(19) United States
(12) Patent Application Publication
(10) Pub. No.: US 2025/0357982 A1
(43) Pub. Date: Nov. 20, 2025

(54) METHODS, APPARATUS, AND SYSTEMS FOR HIERARCHICAL BEAM PREDICTION BASED ON ASSOCIATION OF BEAM RESOURCES

(71) Applicant: InterDigital Patent Holdings, Inc., Wilmington, DE (US)

(72) Inventors: Nazli Khan Beigi, Longueuil (CA); Young Woo Kwak, Woodbury, NY (US); Yugeswar Deenoo Narayanan Thangaraj, Chalfont, PA (US); Patrick Tooher, Montreal (CA); Tejaswinee Lutchoomun, Montreal (CA); Moon IL Lee, Melville, NY (US); Haseeb Ur Rehman, Winnipeg (CA)

(73) Assignee: InterDigital Patent Holdings, Inc., Wilmington, DE (US)

(21) Appl. No.: 18/872,310

(22) PCT Filed: Jul. 7, 2023
(86) PCT No.: PCT/US2023/069765

§ 371 Date: Dec. 6, 2024

Related U.S. Application Data
(60) Provisional application No. 63/388,063, filed on Jul. 11, 2022.

(51) Int. Cl. H04B 7/06; H04L 41/16

(52) U.S. Cl. CPC H04B 7/0626; H04B 7/06952; H04L 41/16

(57) ABSTRACT

A wireless transmit/receive unit (WTRU) may perform channel state information (CSI) measurement(s) on a first set of reference signals (RSs) associated with a first set of transmission configuration indicator (TCI) states. The WTRU may determine CSI parameter(s) for a second set of RSs based on the CSI measurement(s) performed on the first set of RSs. The WTRU may receive a first indication to activate or deactivate a first TCI state in the first set of TCI states. The WTRU may activate or deactivate a second TCI state of the second set of TCI states based on the first indication to activate or deactivate the first TCI state of the first set of TCI states and/or the determined CSI parameter(s) for the second set of RSs. The WTRU may send a second indication that the second TCI state in the second set of TCI states has been activated or deactivated.

### CROSS-REFERENCE TO RELATED APPLICATION

This application claims priority to U.S. Provisional Patent Application No. 63/388,063 filed on Jul. 11, 2022, the entire contents of which are incorporated herein by reference.

### BACKGROUND

Artificial Intelligence (AI)/Machine Learning (ML) may be provided for a new radio (NR) air interface. Beam management may be provided as one of the target use-cases for AI/ML for air interface. Beam management for AI/ML air interface may improve performance and/or complexity in one or more beam management aspects, including beam prediction in time, and/or spatial domain for overhead and/or latency reduction, beam selection accuracy improvement, and/or the like.

Beam selection may be based on beam sweeping at the base station (e.g., gNB) side and/or the WTRU-side. In a second frequency range (e.g., FR2), for example, the beam management may result in beam sweeping and/or measurement over one or more (e.g., a large number of) antennas at the base station and/or the WTRU side. Upon selection of the best beams, for example, the WTRU may report one or more (e.g., up to four) beams (e.g., based on received signal received power (RSRP) in beam management procedure.

Using AI/ML models, FR2 beam selection and/or prediction can be performed based on one or more first frequency range (e.g., FR1) channel state information (CSI) measurements. Realization of such framework may be subject to resolving one or more key challenges in beams' measurement and/or reporting, as well as training and/or validation of the AI/ML model in one or more scenarios with hierarchical spatial relations and/or associations between beam resources in one or more different frequency ranges. This may result in different WTRU behavior in determining the one or more associations, measuring, and/or reporting the beam resources, as well as training, validation, activation and/or deactivation of the one or more AI/ML models. Further investigation into hierarchical beam prediction in NR AI/ML beam management may be provided herein.

### SUMMARY

Methods and apparatuses are provided herein for hierarchical beam prediction based on association of beam resources. Methods and apparatuses are provided herein for dynamic and/or wireless transmit/receive unit (WTRU) performed activation and/or deactivation of transmission configuration index (TCI) states based on hierarchical spatial relation. Methods and apparatuses are provided herein for determination of the association between beam resources. Methods and apparatuses are provided for hierarchical spatial relation for beam prediction.

A WTRU may receive a configuration associated with a first set of beam resources and a second set of beam resources. The beam resources may include a TCI state, a CSI reference signal (CSI-RS), synchronization signal/physical broadcast channel (SS/PBCH) block (SSB) for downlink, and/or a sounding reference signal (SRS) resource for uplink. The first set of beam resources may be in a first frequency range and the second set of beam resources is in a second frequency range. A first beam resource of the first set of beam resources may be associated with a second beam resource of the second set of beam resources. The association between the first beam resource and the second resource may be indicated by one or more of the WTRU or a base station. The WTRU may send one or more channel state information (CSI) parameters associated with the first set of beam resources, for example, based on measurement of the first set of beam resources. The one or more TCI states may be activated a predetermined number of symbols based on the one or more CSI parameters are sent. The WTRU may activate one or more TCI states associated with the second set of beam resources, for example, based on the association of the first beam resource with the second beam resource.

The WTRU may send a first indication of the one or more TCI states. The WTRU may receive a second indication for applying a TCI state based on the first indication. The second indication may be received with a scheduling of a shared channel. The shared channel may be a physical downlink shared channel (PDSCH) or a physical uplink shared channel (PUSCH). The WTRU may report one or more updates associated with the one or more TCI states. The report may be sent based on an artificial intelligence/machine learning (AI/ML) output, one or more measurements of the first set of beam resources, WTRU movement, WTRU rotation, and/or an environmental change.

A WTRU may perform one or more channel state information (CSI) measurements on a first set of reference signals (RSs) associated with a first set of transmission configuration indicator (TCI) states. The WTRU may determine one or more CSI parameters for a second set of RSs based on the CSI measurements performed on the first set of RSs associated with the first set of TCI states, where the second set of RSs may be associated with the first set of RSs. The WTRU may receive a first indication to activate and/or deactivate a first TCI state in the first set of TCI states. The WTRU may receive the first indication via a medium access control (MAC) control element (CE) (MAC-CE). The WTRU may determine to activate and/or deactivate a second TCI state of a second set of TCI states based on the first indication to activate and/or deactivate the first TCI state of the first set of TCI states and/or the determined one or more CSI parameters for the second set of RSs. The WTRU may send a second indication that the second TCI state in the second set of TCI states has been activated and/or deactivated.

A WTRU may determine a spatial association between the first set of RSs and the second set of RSs, where the one or more CSI parameters for the second set of RSs is determined based on the spatial association. The first set of RSs may be associated with a first set of beam resources and/or the second set of RSs may be associated with a second set of beam resources. The first set of beam resources may be in a first frequency range and/or the second set of beam resources may be in a second frequency range. The first set of beam resources may include a larger beamwidth than the second set of beam resources.

A WTRU may determine the one or more CSI parameters for the second set of RSs based on a precoding matrix indicator (PMI) determined from the one or more CSI measurements performed on the first set of RSs associated with the first set of TCI states. The first set of TCI states may be associated with a first frequency range and the second set of TCI states may be associated with a second frequency range. The WTRU may send a report (e.g., to a network), that includes the determined one or more CSI-RS parameters. The WTRU may determine one or more CSI parameters for the second set of RSs based on one or more artificial intelligence (AI) and/or machine learning (ML) models.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example process of dynamic activation/deactivation of transmission configuration index (TCI) states based on hierarchical spatial relation.

FIG. 3 depicts an example flow process diagram of dynamic activation and/or deactivation of TCI states based on hierarchical spatial relation.

FIG. 4 depicts example sets of channel state information (CSI) reference signal (CSI-RS) resources with different beamwidths.

FIG. 5 depicts example sets of CSI-RS resources with different beamwidths where a narrow beam is associated with a determined precoding matrix indicator (PMI) for a specific wide beam.

FIG. 6 depicts an example association of a parent CSI-RS resource with a CSI-RS resource set.

### DETAILED DESCRIPTION

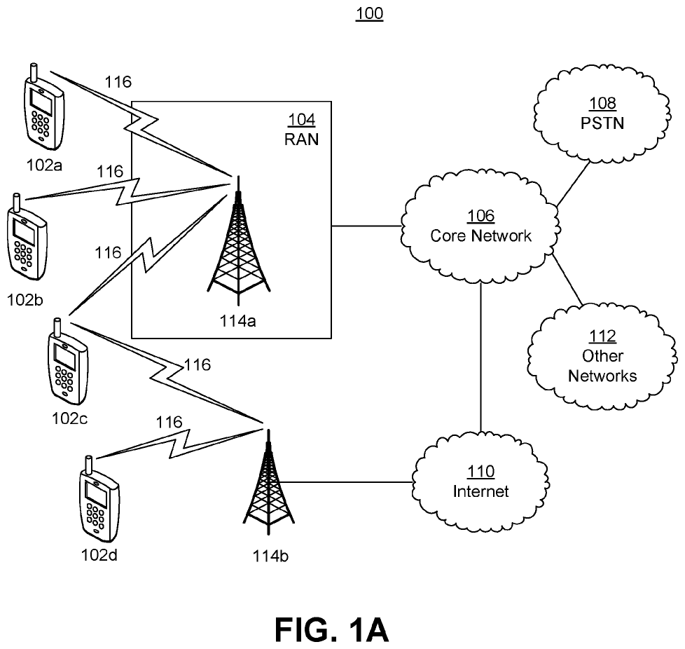

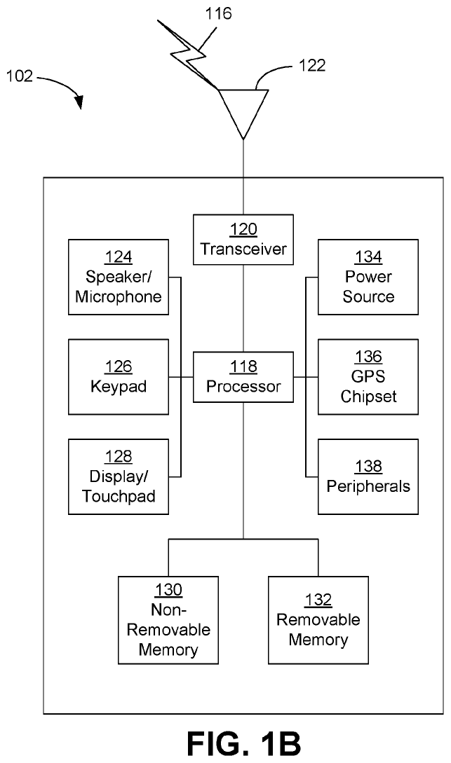

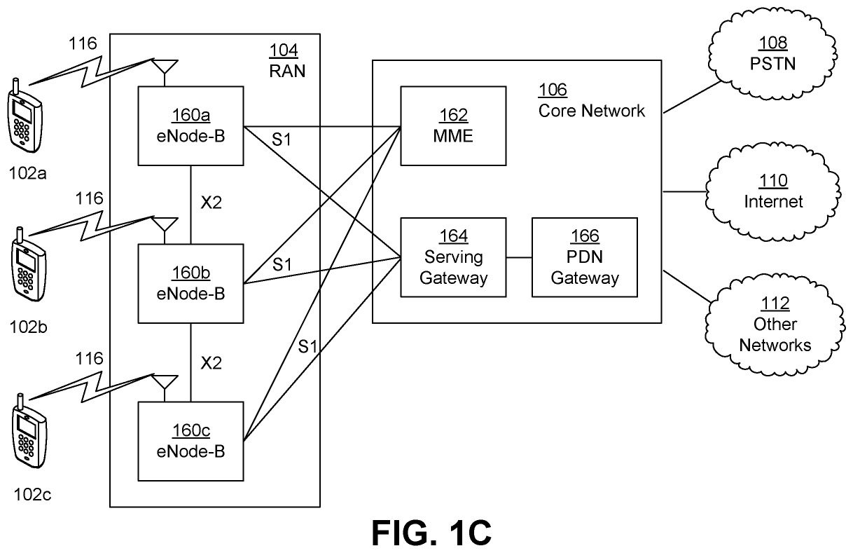

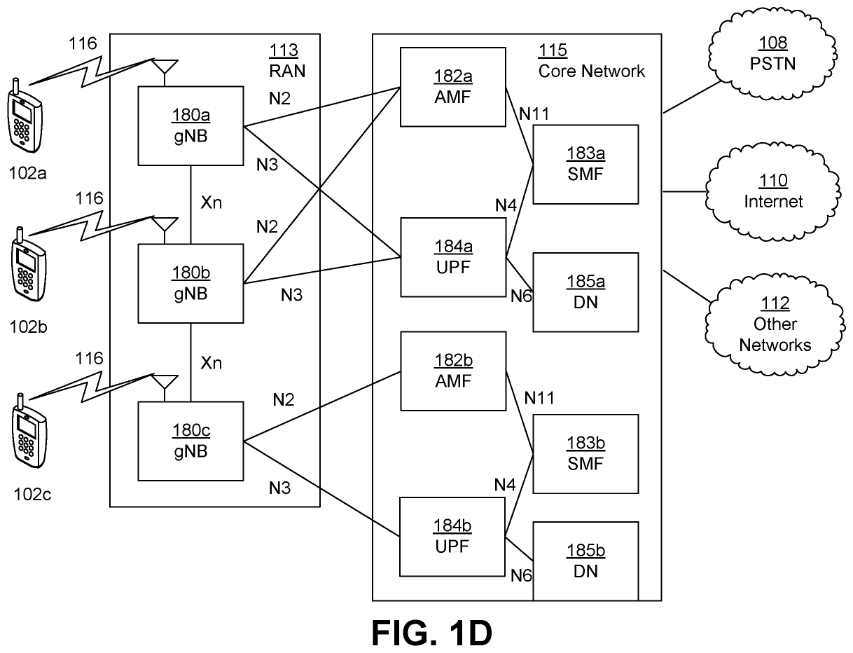

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s orthogonal frequency-division multiplexing (OFDM)), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, based on channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more of AMF 182a, 182b, one or more of UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial Intelligence (AI)/Machine Learning (ML) may be provided for an new radio (NR) air interface. Beam management may be provided as one of the target use-cases for AI/ML for air interface. Beam management for AI/ML air interface may improve performance and complexity in one or more conventional beam management aspects, including beam prediction in time, and/or spatial domain for overhead and latency reduction, beam selection accuracy improvement, and so forth.

The conventional beam selection is based on beam sweeping at base station (e.g., gNB) side and WTRU-side. In a second frequency range (e.g., FR2), the conventional beam management could result in beam sweeping and measurement over large number of antennas at base station and WTRU side. Upon selection of the best beams, the WTRU can report up to four beams (e.g., based on received signal received power (RSRP)) in beam management procedure.

Using AI/ML models, second frequency range (FR2) beam selection and/or prediction may be performed based on first frequency range (e.g., FR1) channel state information (CSI) measurements. However, the realization of such framework is subject to resolving the key challenges in beams' measurement and reporting as well as training and validation of the AI/ML model in scenarios with hierarchical spatial relations and associations between beam resources in different frequency ranges. This results in different WTRU behavior in determining the associations, measuring, and reporting the beam resources, as well as training, validation, activation and/or deactivation of the AI/ML models. Further investigation into hierarchical beam prediction in NR AI/ML beam management may be required.

FR2 beam indication and/or prediction may be supported based on FR1 CSI through association between the beam resources and AI/ML models.

Systems, methods, and apparatuses described herein may include dynamic and WTRU performed activation and/or deactivation of one or more transmission configuration index (TCI) states (e.g., FR2) based on hierarchical spatial relation. The WTRU may active and/or deactivate one or more TCI states based on the association. The WTRU may determine and/or report a set of TCI states of the one or more TCI states as a set of activated and/or deactivated TCI states (e.g., as the output of the AI/ML model).

Systems, methods, and apparatuses described herein may include determination of the associated between beam resources. A gNB and/or the WTRU may indicate the associated between one or more CSI parameters and a beam resource (e.g., for both downlink (DL) and uplink (UL), for each of DL and UL separately). The association at the WTRU side may be WTRU specific. The association at the WTRU side may include training and/or validation based on (e.g., legacy) beam resources and/or AI/ML model. The beam resources may be associated according to a (e.g., new) quasi co-location (QCL) type in the context of (e.g., hierarchical) spatial relations.

Systems, methods, and apparatuses described herein may include hierarchical spatial relation for beam prediction. Hierarchical spatial relation for beam prediction may be based on a first set of channel state information reference signal (CSI-RS) resources and/or based on a second set of CSI-RS resources. A CSI-RS resource of the first set may be associated with one or more CSI-RS resource of the second set. Hierarchical spatial relation for beam prediction may be based on a first SCI-RS resource and/or a first set of CSI-RS resources, where one or more (e.g., some) precoding matrix indicator (PMI) of the first CSI-RS resource may be associated with one or more CSI-RS resources of the first set. Hierarchical spatial relation for beam prediction may be based on a first CSI-RS resource and/or a first set of one or more TCI states, where one or more PMI of the first CSI-RS resource may be associated with one or more TCI states of the first set.

Systems, methods, and apparatuses described herein may include dynamic and WTRU performed activation and/or deactivation of one or more TCI states (e.g., FR2) based on hierarchical spatial relation. A WTRU may receive configuration on a first and/or second set of beam resources. The beam of the first set may be associated with one or more beam resource of the second set. A beam resource may include a TCI state, CSI-RS and/or synchronization signal block (SSB) for downlink, and/or a sounding reference signal (SRS) resource and/or TCI state for uplink. One or more (e.g., some) parameters (e.g., TCI state, PMI, channel quality indicator (CQI), etc.) in the first set may be associated with a beam resource of a second set. A gNB and/or the WTRU may indicate the association between one or more CSI parameters and a beam resource (e.g., for both DL and UL, for DL and/or UL separately). The first and second set of beam resources may be in one or more different frequency ranges (e.g., first set may include FR1 and/or second set may include FR2 beam resources). The WTRU may report one or more CSI parameters based on measurement of the first set of beam resources (e.g., in FR1). The WTRU may activate and/or deactivate one or more TCI states of the second set of beam resources (e.g., in FR2) based on the association, for example, based on processing time (e.g., X symbols after on the WTRU report). The WTRU may determine a set of TCI states of the one or more TCI states as a set of activated and/or deactivated TCI states (e.g., as the output of the AI/ML model). The WTRU may report the set of TCI states to a gNB. The WTRU may receive an indication for applying a TCI state based on the reported set of activated and/or deactivated beam resources from the second set (e.g., based on the codepoint(s) of the downlink control information (DCI) field ‘Transmission Configuration Indication’) with and/or without PDSCH and/or PUSCH scheduling. The WTRU may (e.g., dynamically) report the one or more updates and/or changes to the set of activated and/or deactivated TCI states, for example, if required (e.g., based on AI/ML output and/or according to measurements on first of beam resources, WTRU movement and/or rotation, environmental changes, etc.)

Systems, methods, and apparatuses described herein may include determination of the association between beam resources. A WTRU may receive configuration on a first set and/or second set of beam resources, where a beam resource of the first set may be associated with one or more beam resources of the second set. A beam resource may include a TCI state, CSI-RS or a SSB for downlink, and/or an SRS resource or TCI state for uplink. The first and/or second set of beam resources may be in one or more different frequency ranges (e.g., first set may include FR1, and second set may include FR2 beam resources). The beam resource association may be cell-specific and/or configured at the gNB. The beam resource association may be determined at the WTRU side (e.g., based on AI/ML model) for UL and/or DL beam resources. The association at the WTRU side may be WTRU specific requiring training and/or validation based on (e.g., legacy) beam resources (e.g., FR1 and FR2 beams) and/or AI/ML model. The beam resources may be associated according to a (e.g., new) quasi-colocation (QCL) type in the context of (e.g., hierarchical) spatial relations.

Systems, methods, and apparatuses described herein may include hierarchical spatial relation for a beam prediction as described herein. A WTRU may be configured with a first and/or a second set of CSI-RS resources, where a CSI-RS resource of the first set may be associated with one or more CSI-RS resources of the second set. One or more (e.g., some) PMI/CQI of a CSI-RS in the first set may be associated with a CSI-RS resource of a second set. The first and second set of CSI-RS resources may be in one or more different frequency ranges (e.g., first set may include FR1, and/or the second set may include FR2 CSI-RS resources). The WTRU may determine the PMI of a CSI-RS resource in the first set of CSI-RS resources. The WTRU may determine (e.g., accordingly), one or more CSI-RS resources from the second set (e.g., FR2) that are associated with respective PMI (e.g., FR1). The WTRU may send a request to the gNB for the transmission of one or more of the determined CSI-RS resources from the second set (e.g., FR2). The WTRU may send the CSI report and/or the association between the CSI-RS resources to the gNB. For example, the WTRU may send either the CSI report or the association between the CSI-RS resources to the gNB. The WTRU may measure the CSI-RS resources, for example, from the second set (e.g., FR2) and/or may report the CSI-RS parameter(s) (e.g., accordingly).

Systems, methods, and apparatuses described herein may include hierarchical spatial relation for a second beam prediction as described herein. A WTRU may be configured with a first CSI-RS resource and/or a first set of CSI-RS resources. One or more PMI of the first CSI-RS resource may be associated with one or more CSI-RS resources of the first set. The first CSI-RS resource and/or the first set of CSI-RS resources may be in one or more different frequency ranges (e.g., the first CSI-RS resource may include FR1, and/or the first set of CSI-RS resources may include FR2 CSI-RS resources). The WTRU may determine a PMI of the first CSI-RS resource. The WTRU may determine (e.g., accordingly) one or more CSI-RS resources from the first set (e.g., FR2) that are associated with respective PMI (e.g., FR1). The WTRU may send a request to the gNB for the transmission of one or more of the determined CSI-RS resources from the first set (e.g., FR2). The WTRU may measure the CSI-RS resources from the first set (e.g., FR2) and/or may report the CSI-RS parameter(s) (e.g., accordingly).

Systems, methods, and apparatuses described herein may include hierarchical spatial relation for beam indication. A WTRU may be configured with a first CSI-RS resource and/or a first set of TCI states. Additionally or alternatively, the WTRU may be configured with one or more (e.g., a first and/or a second) CSI-RS resource and/or one or more (e.g., a first and/or second) sets of TCI states (e.g., in multi-transmission/reception point (mTRP) scenarios). One or more (e.g., some) PMI of the first and/or second CSI-RS resource may be associated with one or more TCI states of the first and/or second set. The first and/or second CSI-RS resource and/or the first and/or second set of TCI states may be in one or more different frequency ranges (e.g., the first and/or second CSI-RS resource may include FR1, and/or the first and/or second set of TCI states may include FR2 TCI states). The WTRU may determine a PMI of the first and/or second CSI-RS resource. The WTRU may determine (e.g., accordingly) one or more TCI states from the first and/or second set (e.g., FR2) that are associated with respective PMI (e.g., FR1). If the number of the one or more TCI states is one (e.g., per transmission/reception point (TRP)), for example, the WTRU may apply the TCI state for DL reception and/or UL transmission. If the number of the one or more TCI states is more than one (e.g., per TRP), the WTRU may activate the one or more TCI states for DL reception and/or UL transmission. The WTRU may receive an indication of one or more TCI states to be used for DL reception and/or UL transmission, for example, based on the one or more activated TCI states.

Systems, methods, and apparatuses described herein may relate to how to efficiently support FR2 beam indication and/or prediction based on FR1 CSI through association between the beam resources and/or AI/ML models.

The methods on beam prediction and/or selection based on one or more beam measurements on a different beam resource (e.g., with different beamwidth, frequency range, and so forth) in an AI/ML framework may be provided herein. Association of the beam resources may be described herein, where the one or more beam resources from a first set may be associated with one or more beam resources (e.g., CSI-RS resources, CSI-RS resource sets, and/or sets of TCI-states) of a second set. Dynamic determination of the set of activated/deactivated TCI states may be described herein. A WTRU may (e.g., dynamically) activate and/or deactivate one or more TCI states, for example, based on the association of one or more beam resources. Additionally or alternatively, the WTRU may (e.g., dynamically) indicate, update, and/or report the set of activated and/or deactivated TCI states (e.g., as the output of the AI/ML model). Moreover, determination of the association may be described herein. Determination of the association may include one or more cell-specific beam associations (e.g., at the gNB) and/or one or more WTRU-specific beam associations (e.g., at the WTRU). Moreover, a (e.g., new) QCL type may be described herein. The (e.g., new) QCL type may be used to identify the (e.g., hierarchical) spatial relations between one or more different beam resources (e.g., Type E), as described herein. One or more different types of association between beam resources may be described herein.

Artificial intelligence may be broadly referred to as the behavior exhibited by machines. Such behavior may e.g., mimic one or more cognitive functions to sense, reason, adapt, and/or act.

Machine learning may refer to one or more types of algorithms that solve a problem based on learning through experience (e.g., ‘data’), without (e.g., explicitly) being programmed (e.g., ‘configuring set of rules’). Machine learning can be considered as a subset of Al. Different machine learning paradigms may be envisioned based on the nature of data and/or feedback available to the learning algorithm. For example, a supervised learning approach may involve learning a function that maps input to an output based on labeled training example, wherein one or more (e.g., each) training example may be a pair including input and/or the corresponding output. For example, unsupervised learning approach may involve detecting one or more patterns in the data with an insignificant amount of (e.g., no) pre-existing labels. For example, reinforcement learning approach may involve performing sequence of actions in an environment to maximize the cumulative reward. In examples, machine learning algorithms may be applied using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning with an insufficient amount of (e.g., no) labeled training data and supervised learning with labeled (e.g., only labeled) training data.

Deep learning may refer to class of machine learning algorithms that employ artificial neural networks (e.g., Deep Neural Networks (DNNs)) which were loosely inspired from biological systems. The DNNs are a special class of machine learning models inspired by human brain wherein the input may be linearly transformed and/or pass-through non-linear activation function one or more (e.g., multiple) times. DNNs may include one or more (e.g., multiple) layers where one or more (e.g., each) layer may include linear transformation and/or a given non-linear activation functions. The DNNs can be trained using the training data via back-propagation algorithm. DNNs may have shown state-of-the-art performance in one or more (e.g., a variety of) domains, e.g., speech, vision, natural language etc., and/or for various machine learning settings: supervised, un-supervised, and/or semi-supervised. The term AIML based methods and/or processing may refer to realization of one or more behaviors and/or conformance to one or more requirements by learning based on data, without explicit configuration of sequence of steps of actions. Such methods may enable learning complex behaviors, which might be difficult to specify and/or implement when using one or more (e.g., legacy) methods.

A WTRU may transmit and/or receive a physical channel and/or reference signal according to one or more spatial domain filters. The term “beam” may be used to refer to a spatial domain filter.

The WTRU may transmit a physical channel and/or signal using the same spatial domain filter as the spatial domain filter used for receiving an RS (such as CSI-RS) and/or a SS block. The WTRU transmission may be referred to as “target”, and the received reference signal (RS) or synchronization signal (SS) block may be referred to as “reference” and/or “source”. In such case, the WTRU may be said to transmit the target physical channel and/or signal, for example, according to a spatial relation with a reference to such RS and/or SS block.

The WTRU may transmit a first physical channel and/or signal according to the same spatial domain filter as the spatial domain filter used for transmitting a second physical channel and/or signal. The first and/or second transmissions may be referred to as “target” and/or “reference” (e.g., or “source”), respectively. In such case, the WTRU may be said to transmit the first (e.g., target) physical channel and/or signal, for example, according to a spatial relation with a reference to the second (e.g., reference) physical channel and/or signal.

A spatial relation may be implicit, configured by radio resource control (RRC), and/or signaled by medium access control (MAC) control element (CE) and/or downlink control information (DCI). For example, a WTRU may implicitly transmit physical uplink shared channel (PUSCH) and/or demodulation reference signal (DM-RS) of PUSCH, for example, according to the same spatial domain filter as an SRS indicated by an SRS resource indicator (SRI) indicated in DCI and/or configured by RRC. In examples, a spatial relation may be configured by RRC for an SRI and/or signaled by MAC CE for a physical uplink control channel (PUCCH). Such spatial relation may also be referred to as a “beam indication”.

The WTRU may receive a first (e.g., target) downlink channel and/or signal according to the same spatial domain filter and/or spatial reception parameter as a second downlink channel and/or signal. The first downlink channel and/or signal may be a target downlink channel and/or signal. The second down link channel and/or signal may be a reference downlink channel or signal. For example, such association may exist between a physical channel such as physical downlink control channel (PDCCH) and/or physical downlink shared channel (PDSCH) and/or its respective DM-RS. At least when the first and/or second signals are reference signals, for example, such association may exist when the WTRU is configured with a quasi-colocation (QCL) assumption type D between one or more corresponding antenna ports. Such association may be configured as a transmission configuration indicator (TCI) state. A WTRU may be indicated in an association between a CSI-RS and/or SS block and a DM-RS, for example, by an index to a set of one or more TCI states configured by RRC and/or signaled by MAC CE. The indication of an association between a CSI-RS and/or SS block and a DM-RS may also, and/or alternatively, be referred to as a beam indication.

A transmission and/or reception point (TRP) may be interchangeably used herein with one or more of: a transmission point (TP), a reception point (RP), a radio remote head (RRH), a distributed antenna (DA), a base station (BS), a sector of a BS, and/or a cell (e.g., a geographical cell area served by a BS). A multi-TRP may be interchangeably used herein with one or more of MTRP, M-TRP, and/or multiple TRPs.

A WTRU may report a subset of one or more channel state information (CSI) components, where one or more CSI components may correspond to one or more of: a CSI-RS resource indicator (CRI); a SSB resource indicator (SSBRI); an indication of a panel used for reception at the WTRU (e.g., such as a panel identity and/or group identity); one or more measurements such as L1-RSRP, L1-SINR taken from SSB and/or CSI-RS (e.g., cri-RSRP, cri-SINR, ssb-Index-RSRP, ssb-Index-SINR); and/or one or more other channel state information. One or more other channel state information may include rank indicator (RI), channel quality indicator (CQI), precoding matrix indicator (PMI), Layer Index (LI), and/or the like.

A WTRU may receive a synchronization signal/physical broadcast channel (SS/PBCH) block (SSB). The SSB may include a primary synchronization signal (PSS), a secondary synchronization signal (SSS), and/or a physical broadcast channel (PBCH). The WTRU may monitor, receive, and/or attempt to decode an SSB during initial access, initial synchronization, radio link monitoring (RLM), cell search, cell switching, and/or the like.

A WTRU may measure and/or report the channel state information (CSI). The CSI for one or more (e.g., each) connection mode may include and/or be configured with one or more of following: a CSI Report Configuration, a CSI-RS Resource Set, and/or one or more non-zero power (NZP) CSI-RS resources. The CSI Report Configuration may include a CSI report quantity (e.g., Channel Quality Indicator (CQI), Rank Indicator (RI), Precoding Matrix Indicator (PMI), CSI-RS Resource Indicator (CRI), Layer Indicator (LI), etc.), a CSI report type (e.g., aperiodic, semi persistent, or periodic), a CSI report codebook configuration (e.g., Type I, Type II, Type II port selection, etc.), and/or a CSI report frequency.

A CSI-RS Resource Set may include one or more of the following CSI Resource settings: an NZP-CSI-RS Resource for channel measurement, an NZP-CSI-RS Resource for interference measurement, and/or a CSI-interference measurement (CSI-IM) Resource for interference measurement.

The one or more NZP CSI-RS Resources may include one or more of the following: an NZP CSI-RS Resource identification (ID), a periodicity and offset, QCL Info and TCI-state, and/or a resource mapping (e.g., number of ports, density, code division multiplexing (CDM) type, etc.).

A WTRU may indicate, determine, and/or be configured with one or more reference signals. The WTRU may monitor, receive, and/or measure one or more parameters based on the respective reference signals. For example, one or more of the following may apply. The following parameters are non-limiting examples of the parameters that may be included in reference signal(s) measurements. One or more of these parameters may be included. Other parameters may be included.

An SS reference signal received power (SS-RSRP) may be measured based on the synchronization signals (e.g., demodulation reference signal (DMRS) in PBCH and/or SSS). SS-RSRP may be defined as the linear average over the power contribution of the resource elements (RE) that carry the respective synchronization signal. In measuring the RSRP, power scaling for the reference signals may be required. In case SS-RSRP is used for L1-RSRP, for example, the measurement may be accomplished based on one or more CSI reference signals in addition to the synchronization signals.

A CSI-RSRP may be measured based on the linear average over the power contribution of the resource elements (RE) that carry the respective CSI-RS. The CSI-RSRP measurement may be configured within measurement resources for the configured CSI-RS occasions.

A SS signal-to-noise and interference ratio (SS-SINR) may be measured based on the synchronization signals (e.g., DMRS in PBCH and/or SSS). SS-SINR may be defined as the linear average over the power contribution of the resource elements (RE) that carry the respective synchronization signal divided by the linear average of the noise and interference power contribution. When SS-SINR is used for L1-SINR, for example, the noise and interference power measurement may be accomplished based on one or more resources configured by one or more higher layers.

A CSI-SINR may be measured based on the linear average over the power contribution of the resource elements (RE) that carry the respective CSI-RS divided by the linear average of the noise and interference power contribution. When CSI-SINR is used for L1-SINR, for example, the noise and interference power measurement may be accomplished based on one or more resources configured by one or more higher layers. Otherwise, the noise and interference power may be measured based on the resources that carry the respective CSI-RS.

A received signal strength indicator (RSSI) may be measured based on the average of the total power contribution in configured OFDM symbols and/or bandwidth. The power contribution may be received from one or more different resources (e.g., co-channel serving and/or non-serving cells, adjacent channel interference, thermal noise, and/or the like).

A Cross-Layer interference received signal strength indicator (CLI-RSSI) may be measured based on the average of the total power contribution in configured OFDM symbols of the configured time and/or frequency resources. The power contribution may be received from one or more different resources (e.g., cross-layer interference, co-channel serving and/or non-serving cells, adjacent channel interference, thermal noise, and/or the like).

A sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single bandwidth part (BWP) (e.g., indicated by BWP-Id). One or more of the following parameters may be included in a CSI report configuration: one or more CSI-RS resources and/or one or more CSI-RS resource sets for one or more channel and/or interference measurements; CSI-RS report configuration type including the periodic, semi-persistent, and/or aperiodic; CSI-RS transmission periodicity for one or more periodic and/or semi-persistent CSI reports; CSI-RS transmission slot offset for periodic, semi-persistent, and/or aperiodic CSI reports; CSI-RS transmission slot offset list for one or more semi-persistent and/or aperiodic CSI reports; one or more time restrictions for one or more channel and/or interference measurements; report frequency band configuration (e.g., wideband/subband CQI, PMI, and/or the like); one or more thresholds and/or modes of calculations for the one or more reporting quantities (e.g., CQI, RSRP, SINR, LI, RI, etc.); codebook configuration; group based beam reporting; CQI table; subband size; non-PMI port indication; port Index; and/or the like.

A CSI-RS Resource Set (e.g., NZP-CSI-RS-ResourceSet) may include one or more CSI-RS resources (e.g., NZP-CSI-RS-Resource and/or CSI-ResourceConfig), wherein a WTRU may be configured with one or more of the following in a CSI-RS Resource. A WTRU may be configured with CSI-RS periodicity and/or slot offset for periodic and/or semi-persistent CSI-RS Resources in a CSI-RS Resource. A WTRU may be configured with CSI-RS resource mapping that includes (e.g., to define) one or more (e.g., the number of) CSI-RS ports, density, CDM-type, OFDM symbol, and/or subcarrier occupancy in a CSI-RS Resource. A WTRU may be configured with a bandwidth part to which the configured CSI-RS is allocated in a CSI-RS Resource. A WTRU may be configured with a reference to the TCI-State including the QCL source RS(s) and/or the corresponding QCL type(s) in a CSI-RS Resource.

One or more of the following configurations may be used for an RS resource set. A WTRU may be configured with one or more RS resource sets. An RS resource set configuration may include one or more of following: an RS resource set ID, one or more RS resources for the RS resource set, a Repetition (e.g., on or off), an aperiodic triggering offset (e.g., one of 0-6 slots), and/or tracking reference signal (TRS) info (e.g., true or not).

One or more of the following configurations may be used for an RS resource. A WTRU may be configured with one or more RS resources. The RS resource configuration may include one or more of following: an RS resource ID, a resource mapping (e.g., REs in a physical resource block (PRB)), a power control offset (e.g., one value of −8, . . . , 15), a power control offset with SS (e.g., −3 dB, 0 dB, 3 dB, 6 Db), a scrambling ID, a periodicity and/or offset, and/or QCL information (e.g., based on a TCI state).

A property of a grant and/or assignment may include one or more of the following: a frequency allocation; an aspect of time allocation (e.g., such as a duration); a priority; a modulation and/or coding scheme; a transport block size; one or more (e.g., a number of) spatial layers; one or more (e.g., a number of) transport blocks; a TCI state, CRI and/or SRI; one or more (e.g., a number of) repetitions; whether the repetition scheme is Type A or Type B; whether the grant is a configured grant type 1, type 2 and/or a dynamic grant; whether the assignment is a dynamic assignment and/or a semi-persistent scheduling (e.g., configured) assignment; a configured grant index and/or a semi-persistent assignment index; a periodicity of a configured grant and/or assignment; a channel access priority class (CAPC); and/or one or more (e.g., any) parameter(s) provided in a DCI, by MAC and/or by RRC for the scheduling the grant or assignment.

An indication by DCI may include one or more of the following: an explicit indication by a DCI field and/or by radio network identifier (RNTI) used to mask cyclic redundancy check (CRC) of the PDCCH; and/or an implicit indication by a property such as DCI format, DCI size, Coreset and/or search space, Aggregation Level, first resource element of the received DCI (e.g., index of first Control Channel Element), where the mapping between the property and the value may be signaled by RRC and/or MAC.

RS may be interchangeably used herein with one or more of RS resource, RS resource set, RS port, and/or RS port group. Additionally or alternatively, RS may be interchangeably used herein with one or more of SSB, CSI-RS, SRS, DM-RS, TRS, positioning reference signal (PRS), and/or phase tracking reference signal (PTRS). Additionally or alternatively, a reference signal may be interchangeably used herein with one or more of the following: a Sounding reference signal (SRS), a Channel state information-reference signal (CSI-RS), a Demodulation reference signal (DM-RS), a Phase tracking reference signal (PT-RS), and/or a Synchronization signal block (SSB).

A channel may be interchangeably used herein with one or more of the following: a PDCCH, a PDSCH, a Physical uplink control channel (PUCCH), a Physical uplink shared channel (PUSCH), a Physical random access channel (PRACH), etc.

A RS resource set may be interchangeably used herein with a RS resource and/or a beam group. Beam reporting may be interchangeably used herein with CSI measurement, CSI reporting, and/or beam measurement. One or more of the systems, methods, and/or apparatuses provided herein with respect to beam resource(s) prediction may be used for one or more beam resources belonging to a single and/or one or more (e.g., multiple) cells and/or a single and/or one or more (e.g., multiple) TRPs.

A WTRU may be configured with respect to hierarchical spatial relation for beam prediction. A WTRU may (e.g., dynamically) activate and/or deactivate one or more TCI states. A WTRU may receive configuration (e.g., a configuration message) including one or more TCI-State configurations. For example, the configuration (e.g., configuration message) may include a list of up to M TCI-State configurations. The list of TCI-State configurations may be configured via higher layer parameters (e.g., PDSCH-Config). The number of TCI States included in the list may be up to a configured maximum number of TCI states (e.g., maxNumberConfiguredTCIstatesPerCC=128).

The configuration of a TCI state may include information on the serving cell identity, a bandwidth part identity, and/or a TCI state identity. The TCI-State may include information on configuration of a quasi co-location (QCL) relation between one or more of reference signals (RS) and/or channels. For example, one or more TCI States may be configured for providing reference signals for the QCL relations for DM-RS of PDSCH, DM-RS of PDCCH, CSI-RS port(s) of a CSI-RS resource, positioning reference signal (PRS), tracking reference signal (TRS), uplink spatial relation for PUSCH and/or PUCCH resource transmissions, and/or the like. The WTRU may be configured with one or more QCL types for the one or more reference signals that are linked to the one or more configured TCI States. TCI-State and QCL relation may be used interchangeably herein.

The WTRU may receive a command (e.g., a MAC-CE) for activation and/or deactivation of one or more (e.g., up to eight TCI States) TCI States/pairs of TCI states (e.g., one TCI State for DL and/or one TCI state of UL channels/signals). For example, the activation command may be used to map one or more TCI States to the codepoints of the DCI field ‘Transmission Configuration Indication’ for one or more (e.g., a set of) DL and/or UL CCs/BWPs. The WTRU may receive an indication for applying one of the TCI states, for example, based on the received activated and/or deactivated TCI states. For example, the WTRU may receive the indication via DCI field ‘Transmission Configuration Indication’ (e.g., DCI 1_1, 1_2, 0_1, and/or 0_2), wherein DCI may be with or without DL and/or UL (e.g., PDSCH/PUSCH) scheduling.

In examples, a WTRU may receive a configuration of a first set and a second set of beam resources, where a beam resource in the first set may be associated with one or more of the beam resources in the second set. In examples, a beam resource may include a TCI state, CSI-RS (e.g., CRI, PMI), SSB (e.g., SSB Index), TRS, or PRS for downlink, or an SRS resource (e.g., SRI) or TCI state for uplink, and/or the like (e.g., 208). One or more of the beam resource parameters in the first set may be associated with one or more beam resource parameters in the second set.

The beam resources in the first and/or second set may be in one or more different frequency ranges (e.g., the first set may be in FR1 or FR2-1, and/or the second set may be in FR2 or FR2-2, respectively). Beam resources in different frequency ranges may physically reflect in larger and/or wider beamwidth for the one or more beam resources of the first set compared to the beamwidth of the one or more beam resources of the second set. For example, the first set of beam resources may include a wider and/or larger beamwidth than the second set of beam resources). The beam resources in first and/or second set(s), and the respective association, may be configured such that the WTRU may operate (e.g., simultaneously) with one or more (e.g., both) sets of beam resources. In examples, the WTRU may receive via DL (e.g., SSB, TRS, PRS, PDCCH, PDSCH, and/or the like) and/or transmit via UL (SRS, RACH, PUCCH, PUSCH, and/or the like), for example, while using a beam resource of the first set in respective BWP (e.g., frequency range FR1) along with using a beam resource of the second set in in respective BWP (e.g., frequency range FR2).

In examples, the association between the beam resource sets may be determined at the base station (e.g., gNB) side, wherein the WTRU receives the association configuration from a base station (e.g., gNB). As an example, the WTRU may be configured with a first set of beam resources (e.g., TCI States, CRIs, PMIs, and/or the like) and/or a second set of beam resources (e.g., TCI States, CRIs, and/or the like), where the one or more beam resources of the first set are spatially co-located with the one or more beam resources of the second set. The WTRU may receive a configuration indicating the QCL type (e.g., QCL Type D or a new QCL Type as described herein) relation between the configured beam resources. As such, if the WTRU is configured with a TCI state for the first set of the beam resources, for example, the WTRU may determine to apply the (e.g., same) QCL relation to receive and/or transmit on the one or more associated beam resources from the second set.

Additionally or alternatively, the WTRU may determine the association between the beam resource sets. For example, the WTRU may determine the association based on one or more channel and/or beam measurements (e.g., based on AI/ML). The WTRU may report the determined association to a base station (e.g., a gNB). The WTRU may determine one or more of the beam resources (e.g., TCI States, CRIs, PMIs, and/or the like) from the first set that are spatially co-located with one or more of the beam resources (e.g., TCI States, CRIs, and/or the) from the second set. For example, the WTRU may perform one or more channel state information (CSI) measurements on a first set of reference signals (RSs) associated with a first set of transmission configuration indicator (TCI) states. The WTRU may determine one or more CSI parameters for a second set of RSs based on, for example, the one or more CSI measurements performed on the first set of RSs associated with the first set of TCS states. The second set of RSs may be associated with the first set of RSs. The WTRU may receive an indication to activate and/or deactivate a (e.g., first) TCI state in the first set of TCI states. The WTRU may report one or more of the beam resources in the first set as the reference beam resource. The WTRU may report one or more of the beam resources in the second set that are in QCL relation with the determined reference beam resources. The WTRU may determine and/or report the QCL type (e.g., a Type D QCL or a new QCL Type, as described herein). The WTRU may identify the one or more beam resources in the first and/or second set using reference ID (e.g., CRI, PMI, and/or the like).

The association between the beam resources may be determined for both DL and UL. The association between the beam resources may be determined (e.g., only determined) for DL. The association between the beam resources may be determined (e.g., only determined) for UL.

The WTRU may determine (e.g., dynamically determine) to activate and/or deactivate one or more TCI states. In examples, a WTRU may derive one or more parameters (e.g., PMI, CQI, RSRP taken from SSB and/or CSI-RS, TCI State, and/or the like) for the first set of beam resources, where the WTRU may determine the association between the measured parameters and the second set of beam resources. For example, the WTRU may determine to activate and/or deactivate a (e.g., second) TCI state of a second set of TCI states based on the first indication to activate and/or deactivate the first TCI state of the first set of TCI states and/or the determined one or more CSI parameters for the second set of RSs. The WTRU may report the measured parameters for one or more beam resources in the first set to a base station (e.g., a gNB). Additionally or alternatively, the WTRU may use the configured and/or determined association to report one or more predicted parameters for one or more beam resources in the second set to the base station (e.g., based on AI/ML model). For example, the WTRU may send a second indication that the second TCI state in the second set of TCI states has been activated and/or deactivated.

In examples, a WTRU may receive a command (e.g., MAC-CE) for activation and/or deactivation of one or more (e.g., up to eight TCI States) TCI States and/or pairs of TCI states for the beam resources in the first set. As such, the WTRU may use the configured and/or determined association between the two sets of beam resources to determine one or more TCI States and/or pairs of TCI States corresponding to the beam resources in the second set to be activated and/or deactivated. For example, the WTRU may activate and/or deactivate one or more of the determined TCI States corresponding to the second set of beam resources. The WTRU may activate and/or deactivate the one or more determined TCI States based on the determined and/or configured processing time (e.g., X symbols after the WTRU report). The WTRU may report the determined activated and/or deactivated TCI States to the base station (e.g., gNB) accordingly.

Corresponding and correspondence may be used interchangeably herein. Associating and association may be used interchangeably herein.

Additionally or alternatively, upon reception of a command (e.g., MAC-CE) for activation and/or deactivation of one or more (e.g., up to eight TCI States) TCI States and/or pairs of TCI states for the beam resources in the first set, the WTRU may determine the activation and/or deactivation of one or more TCI States for the beam resources in the second set. In examples, the WTRU may use the association between the two sets of beam resources along with using AI/ML model. As such, for example, the WTRU may activate and/or deactivate the determined TCI States corresponding to the beam resources in the second set based on a determined and/or configured processing time (e.g., X symbols after the WTRU report). The WTRU may report the one or more determined TCI States to the base station (e.g., gNB).

The WTRU may receive an indication for applying a TCI State based on the reported set of the one or more activated and/or deactivated TCI States corresponding to the beam resources in the second set. The indication for applying (e.g., activating or deactivating) a TCI state may be received via an implicit indication or an explicit indication. One or more of the following may apply. With respect to an implicit indication, for example, the WTRU may determine to apply (e.g., activate or deactivate) a TCI State corresponding to the beam resources in the second set based on an indication received for applying (e.g., activate or deactivate) a TCI State in the first set of beam resources. With respect to an explicit indication, for example, the WTRU may receive the indication based on one or more of the codepoints of the DCI field ‘Transmission Configuration Indication’ with and/or without PDSCH and/or PUSCH scheduling.

In examples, the WTRU may (e.g., dynamically) determine one or more TCI States corresponding to the one or more beam resources in the second set to be activated and/or deactivated. In examples, the WTRU may dynamically determine the one or more TCI States based on an AI/ML output and/or according to one or more measurements on first set of beam resources, WTRU movement and/or rotation, one or more environmental changes, and/or the like. As such, for example, the WTRU may dynamically report the one or more determined TCI States to the base station (e.g., gNB).

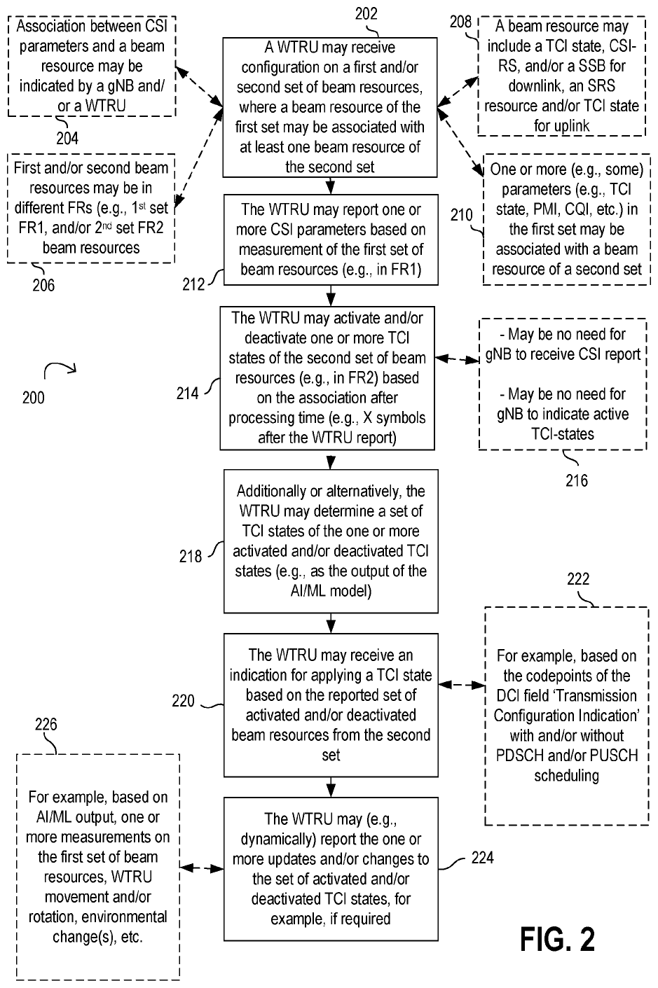

FIG. 2 depicts an example process 200 of dynamic activation and/or deactivation of TCI states based on hierarchical spatial relation.

At 202, a WTRU may receive a configuration (e.g., configuration information) associated with a first set of beam resources and/or a second set of beam resources. A beam resource of the first set may be associated with one or more beam resources of the second set. For example, the first set of RSs may be associated with a first set of beam resources and/or the second set of RSs may be associated with a second set of beam resources. At 208, a beam resource may include a TCI state, a CSI-RS, a synchronization signal/physical broadcast channel (SS/PBCH) block (SSB) for downlink, a sounding reference signal (SRS) resource, and/or a TCI state for uplink. At 210, one or more (e.g., some) parameters (e.g., TCI state, PMI, CQI, etc.) in the first set of beam resources may be associated with a beam resource in the second set of beam resources. At 204, association between CSI parameters and a beam resource may be indicated by a base station (e.g., gNB) and/or the WTRU (e.g., for both DL/UL or each of DL and UL separately). At 206, the first set and second set of beam resources may be in different frequency ranges (e.g., the first set may include FR1, and/or the second set may include FR2 beam resources). For example, the first set of beam resources may be in a first frequency range (FR1) and the second set of beam resources may be in a second frequency range (FR2).

At 212, the WTRU may report one or more CSI parameters based on measurement(s) of the first set of beam resources (e.g., in FR1). At 214, the WTRU may activate and/or deactivate one or more TCI states of the second set of beam resources (e.g., in FR2) based on the association, for example, based on a processing time (e.g., X symbols after the WTRU report). At 216, the WTRU activating and/or deactivating one or more TCI states of the second set of beam resources based on the association based on (e.g., after) processing time may include the gNB not receiving a FR2 CSI report. The WTRU activating and/or deactivating, at 216, one or more TCI states of the second set of beam resources based on the association based on (e.g., after) processing time may include the gNB to not indicate one or more active TCI states. At 218, additionally or alternatively, the WTRU may determine a set of TCI states of the one or more TCI states as a set of activated and/or deactivated TCI states (e.g., as the output of one or more AI/ML models). The WTRU may report the set of one or more TCI states to a base station (e.g., gNB). At 220, the WTRU may receive an indication for applying a TCI state based on the reported set of activated and/or deactivated beam resources from the second set. For example, at 222, the WTRU may receive an indication for applying a TCI state based on the reported set of activated and/or deactivated beam resources from the second set based on the codepoints of the DCI field ‘Transmission Configuration Indication’ with and/or without PDSCH and/or PUSCH scheduling. At 224, the WTRU may (e.g., dynamically) report the update(s) and/or change(s) to the set of activated and/or deactivated TCI states (e.g., if required). At 226, for example, the WTRU may dynamically report the update(s) and/or change(s) to the set of activated and/or deactivated TCI states based on AI/ML output, one or more measurements on first set of beam resources, WTRU movement and/or rotation, one or more environmental changes, and/or the like.

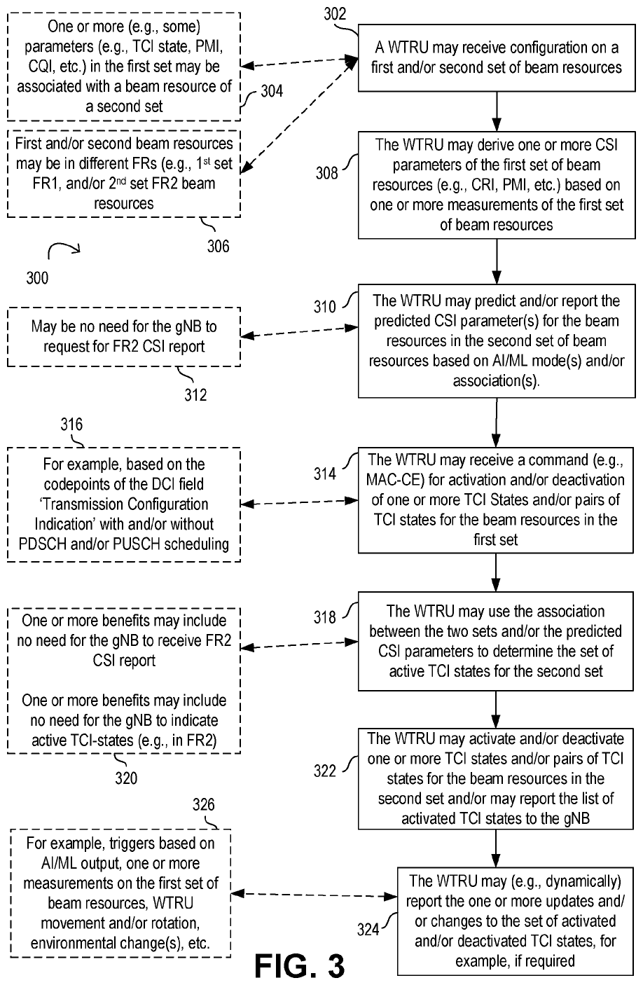

FIG. 3 depicts an example flow diagram of dynamic activation and/or deactivation 300 of one or more TCI states based on hierarchical spatial relation.

At 302, a WTRU may receive configuration information associated with (e.g., for) a first set and/or a second set of associated beam resources. Each beam resource may be associated with one or more RSs. For example, the first set of beam resources may be associated with a first set of RSs (e.g., CSI-RSs) and the second set of beam resources may be associated with a second set of RSs (e.g., CSI-RSs). At 304, one or more parameters (e.g., TCI state, PMI, CQI, etc.) in the first set of beam resources may be associated with one or more beam resources of a second set of beam resources. At 306, the first and second set of beam resources may be in different frequency ranges. For example, the first set of beam resources may be in a first frequency range FR1 and the second set of beam resources may be in a second set of beam resources FR2. The first set of beam resources may have a larger beamwidth than the second set of beam resources.

At 308, the WTRU may derive (e.g., determine) one or more CSI parameters of the first set of beam resources (e.g., CRI, PMI, etc.). For example, the WTRU may derive, at 308, the one or more CSI parameters based on one or more measurements of the first set of beam resources. For example, the WTRU may measure, at 308, the first set of beam resources to determine the one or more measurements. The WTRU may perform one or more CSI measurements on the first set of beam resources. A PMI may be determined from the one or more CSI measurements performed on the first set of beam resources associated with the first set of TCI states. The one or more CSI measurements may include a CSI-reference signal resource indicator (CRI) and/or a PMI.

At 310, the WTRU may determine (e.g., predict) and/or report one or more CSI parameters for the second set of beam resources. For example, the WTRU may determine the one or more CSI parameters for one or more beam resources in the second set of beam resources based on one or more AI/ML models and/or one or more associations (e.g., spatial associations as described herein). For example, at 312, when the WTRU determines the one or more CSI parameters for the beam resources in the second set of beam resources, the gNB may not request a CSI report for the second set of beam resources.

At 314, the WTRU may receive an indication (e.g., MAC-CE, indication) to activate and/or deactivate one or more TCI states and/or pairs of TCI states in the first set of TCI states. For example, the indication may include, at 316, that the activation and/or deactivation of one or more TCI states is based on the codepoints of the DCI field ‘Transmission Config. Indication’ with and/or without PDSCH and/or PUSCH scheduling. The indication may be received by the WTRU via a MAC-CE.

At 318, the WTRU may determine a set of active TCI states for the second set of beam resources. For example, the WTRU may use the association (e.g., such as spatial association) between the two sets of beam resources (e.g., first and second set of beam resources) and/or one or more determined (e.g., predicted) CSI parameters to determine the set of active TCI states for the second set. For example, at 320, when the WTRU determines the set of active TCI states for the second set based on the association and/or the predicted CSI parameters, the gNB may not receive a CSI report for the second set of beam resources and/or the gNB may not indicate one or more TCI states for the second set of beam resources (e.g., in FR2).

At 322, the WTRU may activate and/or deactivate one or more TCI states and/or pairs of TCI states for one or more beam resources in the second set of beam resources. For example, the WTRU may activate and/or deactivate the one or more TCI stats for the one or more beam resources in the second set of beam resources based on the determined (e.g., at 318), set of active TCI states for the second set of beam resources. The WTRU may report, at 322, the list of activated TCI states (e.g., to the gNB).

At 324, for example, the WTRU may (e.g., dynamically) report one or more updates and/or changes to the set of activated and/or deactivated TCI states, for example, if triggered. For example, at 326, The WTRU may send an indication that one or more TCI states of the second set of TCI states has been activated or deactivated. One or more triggers for reporting the updates and/or changes to the set of activated and/or deactivated TCI states may include one or more of AI/ML output(s), one or more measurements on the first set of beam resources, the movement and/or rotation of a WTRU, one or more environmental changes, etc.

In examples, hierarchical spatial relation for beam indication may include one or more of the following. A WTRU may be configured with a first CSI-RS resource and/or a first set of TCI states. Additionally or alternatively, the WTRU may be configured with more than one (e.g., a first and a second) CSI-RS resources and/or more than one (e.g., a first and second) sets of TCI states (e.g., in multi-TRP scenarios). One or more (e.g., some) PMI of the first and/or second CSI-RS resources may be associated with one or more TCI states of the first and/or second set of TCI states. The first and/or second CSI-RS resources and/or the first and/or second sets of TCI states may be in one or more different frequency ranges (e.g., the first and/or second CSI-RS resources may include FR1 and/or the first and/or second sets of TCI states may include FR2 TCI states). For example, the first set of TCI states may be in a first frequency range and the second set of TCI states may be in a second frequency range. The WTRU may determine a PMI of the first and/or second CSI-RS resources. The WTRU may determine one or more TCI states from the first and/or second set (e.g., FR2) that are associated with respective PMI (e.g., FR1). If a number of the one or more TCI states is one (per TRP), the WTRU may apply the TCI state for DL reception and/or UL transmission. If a number of the one or more TCI states is more than one (e.g., per TRP), the WTRU may activate the one or more TCI states for DL reception and/or UL transmission. Based on the activated TCI states, for example, the WTRU may receive an indication of the one or more TCI states to be used for DL reception and/or UL transmission.

A WTRU may receive configuration including one or more sets of CSI-RS resources. The different sets of CSI-RS resources may be for different frequency ranges. For example, the first set of CSI-RS resources may be in a first frequency range (e.g., FR1) and the second set of CSI-RS resources may be in a second frequency range (e.g., FR2). Additionally or alternatively, the different sets of CSI-RS resources may have different beamwidths.

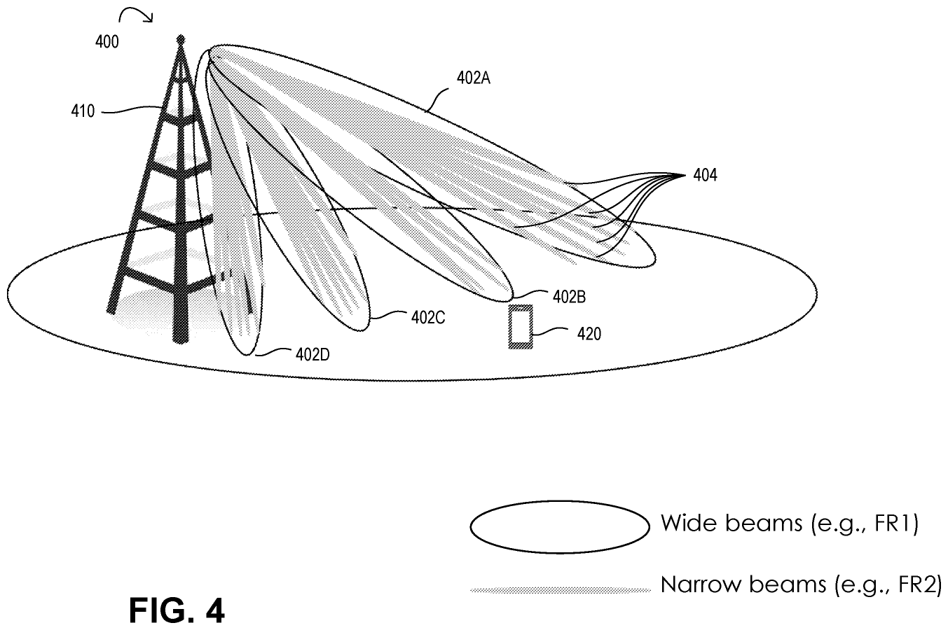

FIG. 4 depicts example sets of CSI-RS resources 400 with different beamwidths. For example, a first set of CSI-RS resources 402A, 402B, 402C, 402D may have a wider beamwidth than a second set of CSI-RS resources 404. For example, the second set of CSI-RS resources 404 may be associated with a narrower beamwidth (e.g., FR2) than the first set of CSI-RS resources 402A, 402B, 402C, 402D. Each beam of the first set of CSI-RS resources 402A, 402B, 402C, 402D may be associated with a direction originating from a base station 410, as shown in FIG. 4.

A WTRU 420 may be configured, determine, and/or identify an association (e.g., a spatial association) between the different sets of CSI-RS resources (e.g., between 402A and 404). For example, the WTRU 420 may determine a spatial association between a first set of RSs 402A and a second set of RSs 404. The one or more CSI parameters for the second set of RSs 404 may be determined based on the spatial association. In examples, the association may be based on hierarchical spatial relations. The WTRU 420 may determine one or more CSI parameters for the second set of RSs 404 based on, for example, one or more artificial intelligence and/or machine learning models.

Spatial association may include one or more of a QCL association between reference signals in different CSI-RS resource sets and/or an association between beams for control channels in different CSI-RS resource sets (e.g., a beam for a first CORESET that is linked to a CSI-RS resource in the first set may be QCL-ed with a beam for a second CORESET that is linked to a CSI-RS resource in the second set). Spatial association, as described herein, may include a spatial relationship between spatial parameters of beam resources. For example, the spatial parameters may include one or more of a beam direction, a beam orientation, a spatial area covered by the beam, a beam center direction, etc. For example, the spatial association may include a comparison between one or more spatial parameters of a first beam resource and one or more spatial parameters of a second beam resource. In examples, a WTRU may be configured with one or more first type and second type of CSI-RS resource sets. One or more CSI-RS resources of a second CSI-RS resource set may be associated with one or more CSI-RS resources of a first CSI-RS resource set. One or more beam resources of the second CSI-RS resource set may be associated with the same CSI-RS resource of the first CSI-RS resource set. Further, a beam resource of the first CSI-RS resource set may be in the same or different frequency range (e.g., lower frequency range) compared to an associated CSI-RS resource of the second CSI-RS resource set.

CSI-RS resources belonging to the first CSI-RS resource set may be used interchangeably herein with a first type of CSI-RS. Further, CSI-RS resources belonging to the second CSI-RS resource set may be used interchangeably herein with a second type of CSI-RS.

In examples, a WTRU may be configured with one or more first type of CSI-RSs and one or more second type of CSI-RS resources. The WTRU may determine a type of CSI-RS resource based on one or more of a frequency range, a base station (e.g., gNB) indication and/or configuration, and/or a subcarrier spacing (SCS).

In examples, the WTRU may determine the type of CSI-RS based on the frequency range which each CSI-RS is associated with. For example, a CSI-RS transmitted with a carrier frequency of FR1 may belong to the first CSI-RS resource set and/or a CSI-RS transmitted with a carrier frequency of FR2 may belong to the second CSI-RS resource set.

In examples, the WTRU may receive an indication and/or a configuration which indicates a type of beam (e.g., based on one or more of RRC, MAC CE, and/or DCI).

In examples, a WTRU may determine the type of CSI-RS based on one or more (e.g., specific) SCSs. For example, the WTRU may determine that the CSI-RS received with a first SCS (e.g., 15 kHz) or a second SCS (e.g., 120 KHz) belong to the first CSI-RS resource set or the second CSI-RS resource set, respectively.

In examples, a WTRU may be configured to associate CSI information (e.g., CQI, PMI and/or L1-RSRP) of one or more CSI-RSs belonging to one CSI-RS resource set (e.g., the second CSI-RS resource set) to one or more CSI-RSs of another CSI-RS resource set (e.g., the first CSI-RS resource set). A WTRU may obtain CSI information of a CSI-RS (e.g., second type of CSI-RS) by performing one or more CSI measurements on an associated CSI-RS (e.g., first type of CSI-RS).

A WTRU may receive configuration information associated with a first set of beam resources and a second set of beam resources. A beam resource of the first set may be associated with at least one beam resource of the second set. For example, a first set of RSs may be associated with the first set of beam resources and a second set of RSs may be associated with the second set of beam resources. A beam resource may include a TCI state, CSI-RS or a SSB for downlink, and/or an SRS resource or TCI state for uplink. The first set and second set of beam resources may be in different frequency ranges. For example, the first set of beam resources may be in a first frequency range (e.g., FR1) and the second set of beam resources may be in a second frequency range (e.g., FR2). The beam resource association may be cell-specific and configured at a base station (e.g., gNB). The beam resource association may be determined by the WTRU (e.g., based on AI/ML model) for UL and/or DL beam resources. The association at the WTRU side may be WTRU specific requiring training/validation based on one or more (e.g., legacy) beam resources (e.g., FR1 and FR2 beams) and/or an AI/ML model. The beam resources may be associated according to a new QCL type in the context of (e.g., hierarchical) spatial relations.

In examples, a WTRU may be configured with a first and second sets of CSI-RS resources, where a CSI-RS resource of the first set may be associated with one or more CSI-RS resources of the second set. In examples, one or more of the measured CSI parameters (e.g., PMI, CQI, or a combination of PMI and CQI) from the first set of CSI-RS resources may be associated with a CSI-RS resource from the second set of CSI-RS resources.

The WTRU may measure the one or more CSI parameters (e.g., RSRP, PMI, CQI, and/or the like) for one or more of the CSI-RS resources in the first set. The WTRU may determine if the one or more measured CSI parameters correspond to one or more of the CSI-RS resources from the second set (e.g., based on the association between the first and second set, AI/ML models, and/or the like).

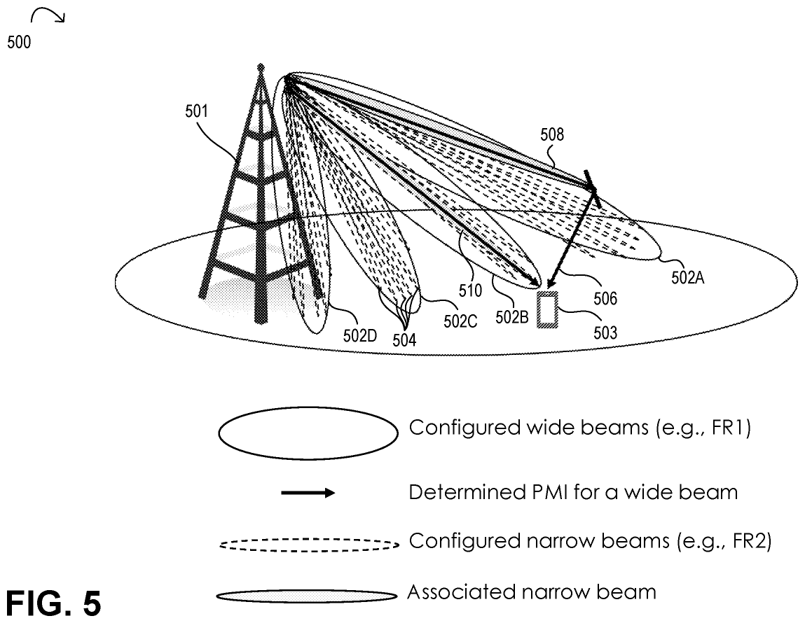

FIG. 5 depicts example sets of CSI-RS resources 500 with different beamwidths where a narrow beam is associated with a determined PMI for a specific wide beam. The base station 501 may initiate a plurality of sets of CSI-RS resources 502A, 502B, 502C, 502D. Each of the sets of CSI-RS resources 502A, 502B, 502C, 502D may include a plurality of CSI-RS resources 504. Although FIG. 5 labels the CSI-RS resources 504 of the set of CSI-RS resources 502C, each of the sets of CSI-RS resources 502A, 502B, 502C, 502D includes the CSI-RS resources 504. A WTRU 503 may determine a CSI parameter 506 (e.g., PMI, CQI, and/or a combination of PMI and CQI) for a first CSI-RS resource 508 of a first set of CSI-RS resources 502A (e.g., FR1 and/or wide beams) as the strongest (e.g., best) PMI 506 to receive and/or transmit signals and/or channels. The WTRU 503 may determine and/or predict one or more strongest (e.g., best) CSI-RS resources from the second resource set 504, for example, based on the determined CSI parameter 506 from the first set 502A, the association between the first set (e.g., wide beams) and the second set 504 (e.g., FR2 and/or narrow beams), and/or the AI/ML model.

The WTRU 503 may report the determined and/or predicted CSI-RS resources from the second set 504 to the base station 501 (e.g., gNB). The WTRU 503 may report measured CSI parameters, determined CSI-RS resources, and/or an association.

For example, the WTRU 503 may report the one or more measured CSI parameters for the first set 502A (e.g., CRI, PMI, CQI, TCI State, and/or the like). In examples, the WTRU 503 may report one or more estimated CSI parameters for the second set 504 (e.g., based on association, AI/ML model, and/or the like). For example, the WTRU 503 may report the determined and/or predicted CSI-RS resources from the second set 504 (e.g., CRI, TCI State, and/or the like). For example, the WTRU 503 may report the determined association between the determined and/or predicted CSI-RS resources from the second set 504 and the reference CSI-RS resources from the first set 502A (e.g., QCL type, spatial relation, and/or the like)

Additionally or alternatively, the WTRU 503 may send a request to the base station 501 (e.g., gNB) for transmission of one or more of the determined and/or predicted CSI-RS resources from the second set 504. The WTRU 503 may receive the (e.g., reported) CSI-RS resources from the second set 504. The WTRU 503 may measure the CSI parameters for the received CSI-RS resources and/or may report the one or more measured CSI-RS parameters (e.g., accordingly).

An indication of a hierarchical spatial association may be provided. In examples, a WTRU may determine an association between one or more CSI-RS resources in one or more CSI-RS resource sets based on one or more of: a base station (e.g., gNB) indication, an ordered PMI ID and/or CSI-RS resources, and/or a WTRU indication.

A WTRU may determine an association between the one or more CSI-RS resource sets based on an indication from a base station (e.g., gNB). For example, the WTRU may receive an explicit indication from a base station (e.g., gNB) based on one or more of RRC, MAC CE, and/or DCI. For example, the WTRU may receive the mapping between the CSI-RS resources of the second set and the configured codebook PMIs corresponding to the CSI-RS resources of the first set. As such, for each CSI-RS resource of the first set and according to the configured codebooks, the WTRU may receive the corresponding CSI-RS resources from the second set that may be mapped to respective PMIs. For example, the WTRU may receive a bitmap that maps the one or more CSI-RS resources from the second set that correspond to the configured codebook PMIs for the CSI-RS resources of the first set (e.g., 0 may indicate no association and/or 1 may indicate association between a PMI and a RS resource).

For example, the WTRU may associate based on ordered PMI IDs corresponding to a CSI-RS resource from the first set and/or CSI-RS resource IDs (e.g., CRI) corresponding to the CSI-RS resources from the second set. For example, for a CSI-RS resource from the first set, first PMI may be associated with a first CSI-RS resource of the second set, and/or a second PMI may be associated with a second CSI-RS resource of the second set, and/or the like.

For example, the WTRU may indicate the association between the determined and/or predicted CSI-RS resources from the second set and a CSI-RS resource from the first set (e.g., QCL type, spatial relation, and/or the like). The indication may be based on a bitmap that maps the CSI-RS resources from the second set that correspond to the configured codebook PMIs for the CSI-RS resources of the first set (e.g., 0 may indicate no association and/or 1 may indicate association between a PMI and a RS resource). The WTRU may receive a confirmation of a base station (e.g., gNB). For example, the WTRU may receive a confirmation of a base station by receiving one or more PDCCHs in one or more CORESETs (e.g., possibly) associated with the WTRU report configuration.

In examples, hierarchical spatial relation for beam predication may include one or more of the following. A WTRU may be configured with a first set of CSI-RS resources and a second set of CSI-RS resources. A CSI-RS resource of the first set of CSI-RS resources may be associated with at least one CSI-RS resource of the second set of CSI-RS resources. One or more (e.g., some) PMI and/or CQI of a CSI-RS in the first set of CSI-RS resources may be associated with a CSI-RS resource of the second set of CSI-RS resources. The first and second set of CSI-RS resources may be in different frequency ranges (e.g., first set may include FR1, and second set may include FR2 CSI-RS resources). The WTRU may determine the PMI of a CSI-RS resource in the first set of CSI-RS resources. The WTRU may determine one or more CSI-RS resources from the second set (e.g., FR2) that are associated with respective PMI (e.g., FR1). The WTRU may send a request to a base station (e.g., gNB) for the transmission of one or more of the determined CSI-RS resources from the second set (e.g., FR2). The WTRU may send the CSI report and/or the association between the CSI-RS resources to the base station (e.g., gNB). The WTRU may (e.g., then) measure the CSI-RS resources from the second set (e.g., FR2) and may report the CSI-RS parameters (e.g., accordingly).

In examples, hierarchical spatial relation for beam prediction may include one or more of the following. A WTRU may be configured with a first CSI-RS resource and a first set of CSI-RS resources. One or more PMI of the first CSI-RS resource may be associated with one or more CSI-RS resources of the first set. The first CSI-RS resource and the first set of CSI-RS resources may be in different frequency ranges (e.g., the first CSI-RS resource may include FR1, and the first set of CSI-RS resources may include FR2 CSI-RS resources). The WTRU may determine a PMI of the first CSI-RS resource. The WTRU may determine one or more CSI-RS resources from the first set of CSI-RS resources (e.g., FR2) that are associated with respective PMI (e.g., FR1). The WTRU may send a request to a base station (e.g., gNB) for the transmission of one or more of the determined CSI-RS resources from the first set (e.g., FR2). The WTRU may (e.g., then) measure the CSI-RS resources from the first set (e.g., FR2) and/or may report the CSI-RS parameters (e.g., accordingly).

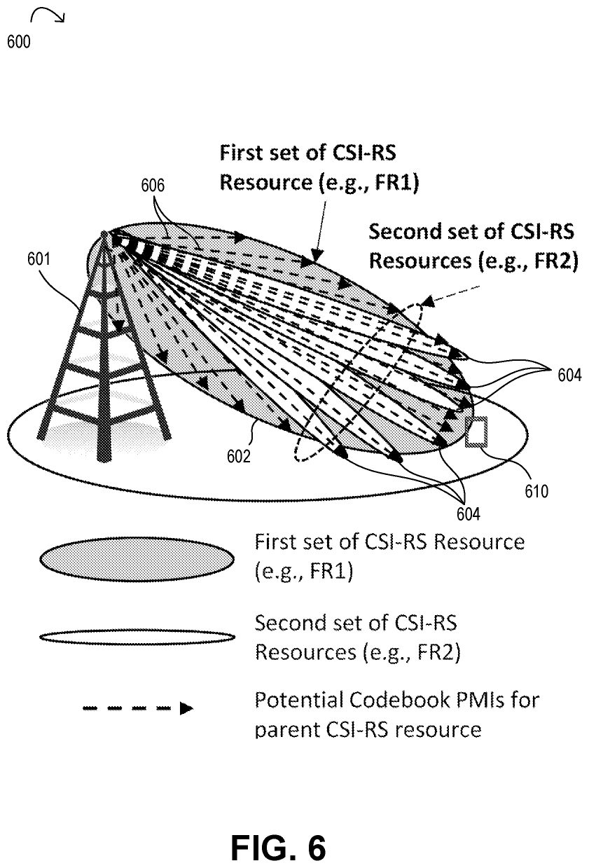

Association of parent CSI-RS resource and CSI-RS resource sets may be provided herein. A WTRU may receive configuration including a first CSI-RS resource and a first set of CSI-RS resources. The first CSI-RS resource may be referred to as a parent and/or a fallback CSI-RS resource. The first CSI-RS resource and the first CSI-RS resource set may be in different frequency ranges. For example, the first CSI-RS resource may be in a first frequency range (e.g., FR1) and/or the first set of CSI-RS resources may be in a second frequency range (e.g., FR2). Additionally or alternatively, the first CSI-RS resource and the first set of CSI-RS resources may have different beamwidths. For example, the first CSI-RS resource (e.g., the parent CSI-RS resource) may have a wider beamwidth and/or the first set of CSI-RS resources may have a narrower beamwidth (e.g., FR2 as depicted in FIG. 6).

FIG. 6 depicts an example association 600 of a parent (e.g., first set of) CSI-RS resources 602 (e.g., FR1) with a second set of CSI-RS resources 604 (e.g., FR2). A WTRU 610 may be configured, determine, and/or identify an (e.g., spatial) association between the first CSI-RS resource set 602 and the second set of CSI-RS resources 604. In examples, the association may be based on hierarchical spatial relations. In FIG. 6, the parent CSI-RS resource set 602 (e.g., with wide beamwidth) and the second set of CSI-RS resources 604 (e.g., with narrower beamwidths) are shown, where the potential PMIs corresponding to the parent CSI-RS resource codebook 606 are provided.

Spatial association may include one or more of the following. Spatial association may include a QCL association between CSI parameters (e.g., PMI 606) in the first set of CSI-RS resources 602 and one or more CSI-RS resources in the second set of CSI-RS resources 604. Spatial association may include an association between beams for control channels in the first set of CSI-RS resources 602 and the second set of CSI-RS resources 604 (e.g., a beam for a first CORESET that is linked to the first CSI-RS resource may be QCL-ed with a beam for a second CORESET that is linked to a CSI-RS resource in the set of CSI-RS resources 604).

In examples, the WTRU 610 may derive (e.g., determine) one or more CSI parameters (e.g., PMI 606) for the first and/or parent CSI-RS resource set 602 (e.g., FR1). The WTRU may determine one or more CSI-RS resources of the second set of CSI-RS resources 604 (e.g., FR2) that are associated with the measured CSI parameters (e.g., PMI 606) for the first and/or parent CSI-RS resource of the first CSI-RS resource set 602 (e.g., FR1). In examples, the WTRU 610 may determine the association based on one or more AI/ML models. In examples, the WTRU 610 may receive one or more CSI configurations from a base station 601 (e.g., gNB) that include the association between the first and/or parent CSI-RS resource set 602 and the second set of CSI-RS resources 604.

In examples, a WTRU 610 may receive configuration that indicates one or more CSI-RS resources from a second set of CSI-RS resources 604 (e.g., FR2) are associated with one or more CSI parameters (e.g., PMI 606) of the parent and/or first CSI-RS resource set 602 (e.g., FR1). For example, the WTRU 610 may receive configuration indicating QCL relation between a PMI in the parent CSI-RS resource set 602 and one or more CSI-RS resources from the second set of CSI-RS resources 604. The QCL relation may be between the determined PMI for the parent and/or first downlink reference signal and

DM-RS ports of the PDSCH, the DM-RS port of PDCCH, the CSI-RS port(s) of a CSI-RS resource, and/or the PRS port of a PRS reference. As such, the WTRU 610 may determine to apply the same QCL relationship to the associated CSI-RS resources in the second resource set 604. For example, as illustrated in FIG. 6, QCL relation information may be configured in a resource set of a parent and/or first reference signal. In that case, for example, the WTRU 610 may determine to apply the QCL relationship to one or more determined resources in the second resource set 604.

In examples, the WTRU 610 may report the determined CSI parameters for the parent and/or first CSI-RS resource set 602 (e.g., FR1) to the base station 601 (e.g., gNB). Additionally or alternatively, the WTRU 610 may report the determined and/or predicted CSI-RS resources from the second resource set 604 (e.g., FR2) to the base station 601 (e.g., gNB). For example, if there is one (e.g., only one) CSI-RS resource from the second resource set 604 that is associated with the determined PMI, the WTRU 610 may report the single CSI-RS resource.

In examples, the WTRU 610 may send a request to a base station 601 (e.g., gNB) for the transmission of one or more of the determined CSI-RS resources from the second set of resources 604. For example, if there is more than one CSI-RS resource from the second resource set 604 that is associated with the determined PMI (e.g., 606), the WTRU 610 may send the request for the determined CSI-RS resources. The WTRU 610 may (e.g., then) measure the received CSI-RS resources from the second resource set 604 (e.g., FR2) and/or may report the one or more CSI-RS parameters (e.g., accordingly).

An indication of a hierarchical spatial association for the parent resource may be provided. In examples, a WTRU may determine the association between the parent and/or first CSI-RS resource and the first CSI-RS resource set based on one or more of: a base station (e.g., gNB) indication, an ordered PMI ID and/or CSI-RS resources, and/or a WTRU indication. The WTRU may receive an (e.g., explicit) indication from a base station (e.g., gNB), for example, based on one or more of RRC, MAC CE, and/or DCI. For example, the WTRU may receive the mapping between the CSI-RS resources from the first set and the configured codebook PMIs (e.g., at 606) corresponding to the parent and/or first CSI-RS resource. As such, for one or more (e.g., each) PMI in the parent and/or first CSI-RS resource and/or according to the configured codebooks, for example, the WTRU may receive the corresponding CSI-RS resources from the first set that may be mapped to respective PMIs. For example, the WTRU may receive a bitmap that maps the CSI-RS resources from the first set that correspond to the configured codebook PMIs for the parent and/or first CSI-RS resource (e.g., 0 may indicate no association and/or 1 may indicate association between a PMI and a RS resource).

A WTRU may receive one or more associations based on ordered PMI IDs corresponding to the parent and/or first CSI-RS resource and CSI-RS resource IDs (e.g., CRI) corresponding to the CSI-RS resources from the first set. For example, for the parent and/or first CSI-RS resource, a first PMI may be associated with a first CSI-RS resource of the first set, and/or a second PMI may be associated with a second CSI-RS resource of the first set, and/or the like.

A WTRU may indicate the association between the determined and/or predicted CSI-RS resources from the first set and the parent and/or first CSI-RS resource (e.g., QCL type, spatial relation, and/or the like). The indication may be based on a bitmap that maps the CSI-RS resources from the first set that correspond to the configured codebook PMIs for the parent and/or first CSI-RS resource (e.g., 0 may indicate no association and/or 1 may indicate association between a PMI and a RS resource). The WTRU may receive a confirmation of a base station (e.g., gNB). The WTRU may receive a confirmation of a base station, for example, by receiving one or more PDCCHs in one or more CORESETs (e.g., possibly) associated with the WTRU report configuration.

CSI-RS resources may be associated with one or more sets of TCI states. A RS resource may be used interchangeably herein with a TCI state.

In examples, a WTRU may be configured with one or more RS resources (e.g., in a RS resource set). One or more (e.g., each) of the one or more RS resources may be associated with a set of TCI states. The WTRU may determine the association based on one or more of: a base station (e.g., gNB) Explicit indication; an RS resource ID and/or a TCI state ID; beam information; and/or a WTRU indication.

A WTRU may receive the explicit indication from a base station (e.g., gNB) based on one or more of RRC, MAC CE and DCI. For example, the WTRU may receive a bitmap of one or more TCI states for one or more (e.g., each) RS resource (e.g., 0 may indicate no association and/or 1 may indicate association between a TCI state and a RS resource). In examples, the WTRU may receive an indication of associated TCI state IDs for a RS configuration. In examples, the WTRU may receive an indication of associated RS IDs for a TCI state.

A WTRU may associate based on RS resource IDs and/or TCI state IDs. For example, 1˜X TCI states may be associated with a first RS and X+1˜Y TCI states may be associated with a second RS.

A WTRU may associate a RS resource and one or more TCI states based on beam information (e.g., beam direction, beam width, etc.).

A WTRU may indicate associated TCI states with a RS ID. For example, the WTRU may report CRI and/or SSBRI and/or associated TCI State Indexes (TSI). TSI may be reported based on one or more TCI state IDs and/or bitmaps (e.g., each bit may indicate association of a TCI state). For example, 0 may indicate no association and 1 may indicate association. The WTRU may receive a confirmation of a base station (e.g., gNB). The WTRU may receive a confirmation of a base station, for example, by receiving one or more PDCCHs in one or more CORESETs (e.g., possibly) associated with the WTRU report configuration.

In examples, one or more (e.g., each) TCI state of the set of TCI states may be associated with one or more PMIs of the associated RS resource. The one or more PMIs may be wideband PMIs. The WTRU may determine the association based on one or more of: a base station (e.g., gNB) Explicit indication; a PMI ID and/or a TCI state ID; beam information; and/or a WTRU indication. The WTRU may receive the explicit indication from a base station (e.g., gNB) based on one or more of RRC, MAC CE, and/or DCI. For example, the WTRU may receive a bitmap of one or more PMIs for one or more (e.g., each) RS resource (e.g., 0 may indicate no association and/or 1 may indicate association between a PMI and a RS resource). In examples, the WTRU may receive an indication of associated PMI IDs for a RS configuration. In examples, the WTRU may receive an indication of associated RS IDs for a PMI.

A WTRU may associate based on one or more PMI IDs and/or one or more TCI state IDs. For example, first PMI may be associated with a first TCI state and/or a second PMI may be associated with a second TCI state and etc.

A WTRU may associate a PMI and a TCI state based on beam information (e.g., beam direction, beam width, etc.).

A WTRU may indicate associated PMI with a TCI state. For example, the WTRU may report PMI and an associated TSI. TSI may be reported based on a TCI state ID or a bitmap (e.g., each bit with 1 may indicate an associated TCI state). For example, one bit (e.g., only one bit) of the TSI may be 1 and/or one or more other bits of the TSI may be 0. The WTRU may receive a confirmation of a base station (e.g., gNB), for example, by receiving one or more PDCCHs in one or more CORESETs (e.g., possibly) associated with the WTRU report configuration.

Based on the association between an RS resource and one or more TCI states, for example, the WTRU may activate the one or more TCI states (e.g., for receiving and/or transmitting one or more signals and/or channels). The WTRU may activate the one or more TCI states based on one or more of the following: a TCI state indication, an RS indication, and/or a WTRU report.

A WTRU may activate one or more TCI states (e.g., for a second FR) based on the received TCI state indication (e.g., for a first FR). For example, the WTRU may receive a TCI state comprising a RS resource (e.g., for QCL Type-D) via one or more of RRC, MAC CE, and/or DCI. The WTRU may activate one or more TCI states with the RS resource.

A WTRU may activate one or more TCI states (e.g., for a second FR) based on the received RS indication (e.g., for a first FR). For example, the WTRU may receive a RS index (e.g., SRI) indicating a RS resource via one or more of RRC, MAC CE, and/or DCI. The WTRU may activate one or more TCI states with the RS resource.

A WTRU may activate one or more TCI states (e.g., for a second FR) based on the reported RS index (e.g., for a first FR). For example, the WTRU may report a RS resource index (e.g., via CRI/SSBRI in a CSI report and/or PRACH transmission associated with a RS). The WTRU may receive a confirmation of the WTRU report (e.g., by receiving one or more PDCCHs in one or more CORESETs possibly associated with the WTRU report configuration). The WTRU may activate one or more TCI states associated with the RS resource.

Based on the association between a PMI and a TCI state, for example, the WTRU may apply the TCI state (e.g., for receiving and/or transmitting one or more signals and/or channels). For example, the WTRU may apply one or more TCI states (e.g., for a second FR) based on the reported PMIs (e.g., for a first FR). The WTRU may report one or more PMIs (e.g., via a CSI report). Based on the WTRU report, for example, the WTRU may receive a confirmation of the WTRU report (e.g., by receiving one or more PDCCHs in one or more CORESETs possibly associated with the WTRU report configuration) from a base station (e.g., gNB).

A WTRU may determine a processing time for TCI state activation and/or application. In examples, a WTRU may apply one or more different processing times for activating and/or applying one or more TCI states. For example, if an (e.g., newly) indicated RS resource for activating one or more TCI states is same with a previously indicated RS resource, the WTRU may apply one or more determined TCI states after X (e.g., symbols/ms) from a base station (e.g., gNB) indication and/or confirmation and/or the WTRU report. If the (e.g., newly) indicated RS resource for activating one or more TCI states is different with the previously indicated RS resource, for example, the WTRU may apply the determined TCI states after Y=X+N (e.g., symbols/ms) from the base station (e.g., gNB) indication and/or confirmation and/or the WTRU report.

Determination of an association between beam resources may be provided herein. Different to mmWave (e.g., FR2), sub-6 GHZ (e.g., FR1) channels may be acquired with lower training overhead. Furthermore, the propagation of the sub-6 GHz signals can be more robust to blockages than that of the mmWave. As such, some association and/or correlation in space/time/frequency between the sub-6 GHz channel(s) and the mmWave channels may be leveraged to assist in reducing the high training overhead for mmWave and/or may maintain reliable and/or robust links.

The high beamforming overhead of mmWave may be reduced by exploiting the spatial correlations between the two bands. In examples, a coarse angle of arrival (AoA) estimation on the sub-6 GHz channel can be obtained to narrow the search space for the one or more mmWave channels. The one or more mmWave channels may be used for fine-tuning and/or one or more transmissions. This exercise may limit the angular range over which the mmWave transmitter may need to scan (e.g., from 180° in a standalone mmWave system to, for e.g., ≤20° on average).

In addition to beamforming overhead, for example, mmWave channels can be significantly (e.g., very) variable with intermittent connectivity since objects tend to lead to blockages and/or reflections as opposed to scattering and/or diffraction in (e.g., typical) sub-6 GHz frequency channels. This may especially be the case when WTRUs and/or objects in proximity to WTRUs are in motion, making the different propagation paths highly variable with intermittent off periods leading to potential long ‘outages’ and/or poor mmWave system performance. Leveraging associations between the bands (e.g., association between hierarchical beam resources) can assist in mitigating variability with intermittent connectivity.

Such association may be applicable for indoor and/or outdoor settings but may be more applicable under line of sight (LOS) conditions. Such association may serve to reduce overhead (e.g., for training and/or regular operation) as well as act as a fallback mechanism if one system were to experience inadequate (e.g., poor) conditions (e.g., bad link quality). In examples, one or more (e.g., multiple) objects blocking LOS communication between the transmitter and receiver may result in the WTRU favoring the sub-6 GHz channels which are more tolerant to blockages over the mmWave channels for a period of time.

A WTRU may receive configuration on a first and/or second set of beam resources, where a beam resource of the first set may be associated with one or more beam resources of the second set. A beam resource may include a TCI state, CSI-RS and/or a SSB for downlink, and/or an SRS resource or TCI state for uplink. The first and second set of beam resources may be in different frequency ranges (e.g., first set may include FR1 beam resources, and/or second set may include FR2 beam resources). The association may be between like beam resources. In examples, a first beam resource in terms of a TCI state in a first frequency range (e.g., FR1) may be associated to a second beam resource in terms of a TCI state in a second frequency range (e.g., FR2). In examples, a first beam resource in terms of downlink (e.g., SSB) in one time instant may be associated to a second beam resource for downlink (e.g., SSB) at a future time instant.

The association may be between different beam resources and/or parameters. In examples, a beam resource in an uplink transmission (e.g., SRS) may be associated with a beam resource in the (e.g., subsequent) downlink transmission (e.g., SSB).

One or more (e.g., any) associations from one beam resource to another beam resource may be direct. In examples, there may be a direct association between a first beam resource in a first frequency range (e.g., FR1) and a second beam resource in a second frequency range (e.g., FR2) through a coarse angle of arrival estimation (e.g., on the sub-6 GHz channel) directly corresponding to an angular range (e.g., for the mmWave transmitter) to scan (e.g., as opposed to the mmWave transmitter having to scan a wider range).

One or more (e.g., any) associations from one beam resource to another beam resource may be indirect with one or more intermediate hops/nodes. In examples, there may be a function (e.g., f(.)) that maps a first channel (e.g., sub-6 GHz channel) to position and/or another function (e.g., g(.)) that maps position to a first achievable rate (e.g., mmWave). Since the two functions may have the same co-domain (e.g., set of candidate user positions), for example, there may exist a composite function (e.g., fg(.)) that can predict optimal first achievable rate (e.g., mmWave) using the first channel (e.g., sub-6 GHZ), going through beam position as an intermediary node. The optimal second (e.g., mmWave) achievable rate may (e.g., then) directly map to the optimal beam. In examples, there may be more than one intermediate node in forming the association between a first beam resource and a second beam resource.

In examples, the association may be bijective such that a first beam resource may map (e.g., only map) to one second beam resource.

In examples, one beam resource may map to more than one other beam resource such that the WTRU may determine which second beam resource is more suitable to use. The WTRU may determine which second beam resource is more suitable to use based on, for example, one or more additional measurements and/or historical information. In examples, if the AIML model associates one beam resource in a first frequency range (e.g., FR1) to two beam resources in a second frequency range (e.g., FR2), the WTRU may request a base station (e.g., gNB) to transmit the two beams in the second frequency range. The WTRU may perform one or more measurements on the two beam resources in the second frequency range (e.g., RSRP measurements) and/or may determine the more suitable resource in the second frequency range based on the measured parameter (e.g., with higher measured RSRP). In examples, the WTRU may determine the most suitable resource based on one or more previous associations (e.g., historical information on beam resource associations).

The WTRU may determine beam resource association (e.g., based on AIML models configured at the WTRU) for UL and/or DL beam resources. The AIML models at the WTRU may be a subset of models out of a list of standardized AIML models and/or the models may be downloaded from the base station (e.g., gNB).

The beam resource association at the WTRU side may be WTRU specific requiring training and/or validation based on one or more (e.g., legacy) beam resources (e.g., FR1 and FR2 beams) and/or AI/ML model.

In examples, a WTRU may be configured to determine the validity of one or more (e.g., any) beam resource associations (e.g., made by the AIML model). In examples, the WTRU may perform one or more additional measurements to make the assessment. For example, if the AIML model at the WTRU outputs an association between a beam resource in a first frequency range (e.g., FR1) and a second beam resource in the second frequency range (e.g., FR2), the WTRU may perform (e.g., CSI) measurements (e.g., RSRP) on the beam resource in the second frequency range to determine if the association is strong enough.

The beam resource association may be determined and/or configured by the base station (e.g., gNB) and/or network. One or more (e.g., each) base stations (e.g., gNB) in a network may have one or more different mapping rules and/or functions to determine the association between beam resources and/or different AIML models and/or different types of AIML models outputting different beam resource association.

The beam resource association may be cell specific. Cell specific beam resource association may include macro cells and/or small cells (e.g., femtocells, picocells, microcells, etc.) for 5G and beyond technologies, where the one or more (e.g., each) 5G and beyond technologies may cover potentially different coverage radii. In examples, a base station (e.g., gNB) from a macro cell may form association between different set of beam resources to a base station (e.g., gNB) from a small cell.

The WTRU may receive one or more indications from the base station (e.g., gNB) about such associations if determined by the base station (e.g., gNB). Indications may be periodic and/or semi-persistent, and/or event triggered (e.g., aperiodic). In examples, the WTRU may receive an indication from the base station (e.g., gNB) at one or more (e.g., every) instances of the base station (e.g., gNB) determining an association between two beam resources or the base station (e.g., gNB) determining that a past association no longer holds. For example, the base station (e.g., gNB) may determine that a second frequency band/range (e.g., mmWave) cannot be used for a time interval (e.g., based on AIML models) based on beam and/or blockage prediction and/or the base station (e.g., gNB) may send an indication to the WTRU (e.g., in DCI) to inform the WTRU to favor/prioritize a first frequency band/range (e.g., sub-6 GHz channels) for respective time interval. In examples, the WTRU may receive an indication from the base station (e.g., gNB) to terminate a past association (e.g., based on a re-run of the AIML model at the base station (e.g., gNB) and/or based on recent WTRU movement making past association no longer accurate, information that the base station (e.g., gNB) may have from updated positioning information). The WTRU may be configured to receive and/or monitor for association information from the base station (e.g., gNB) on a periodic basis with one or more periodicity options configured by the base station (e.g., gNB). Additionally or alternatively, the WTRU may be configured to receive association from the base station (e.g., gNB) on a semi-periodic (e.g., semi-persistent) basis, for example, with a set periodicity unless triggered by an event before the interval time of the periodicity. A network (e.g., base station) may determine an event. For example, an event may include the base station (e.g., gNB) determining a (e.g., new) association between one beam resource and another beam resource. In examples, an event may include an association between one beam resource and another beam resource may have to be strong (e.g., beyond a preconfigured threshold). In this example (e.g., association beyond a preconfigured threshold), one or more soft probabilities may be included (e.g., considered). For example, an event may include the information inferred from one or more measurements for a second frequency band/range (e.g., mmWave band) made in a first frequency band/range (e.g., sub-6 GHZ) has a success rate (e.g., PDSCH block error rate (BLER), PDCCH Hypothetical BLER lower than a threshold) in being a robust channel in the second frequency band/range (e.g., mmWave band).

In examples where the beam resource association is determined at the base station (e.g., gNB), the WTRU may be configured to provide feedback on such association. In examples, the WTRU may assess and/or determine the validity of the association determined at the base station (e.g., gNB). For example, the WTRU may assess and/or determine the validity of the association determined at the base station based on the WTRU measuring CSI parameters (e.g., RSRP), in the second frequency range (e.g., FR2). As such, the WTRU may request for a refreshed assessment of the association at the base station (e.g., gNB). The WTRU may request for a refreshed assessment of the association at the base station, for example, by sending an indication to the base station (e.g., gNB). For example, the WTRU may request for a refreshed assessment of the association at the base station by sending an indication to the base station (e.g., gNB) in UCI. In examples, the WTRU may request for more frequent indication of the association information from the base station (e.g., gNB). The WTRU may request more frequent indication of the association information from the base station, for example, based on one or more WTRU measurements on CSI parameters (e.g., RSRP) in the second frequency range (e.g., FR2). In examples, the WTRU may determine a high mobility scenario (e.g., sensors in WTRU measuring frequent and/or higher than usual mobility). As such, the WTRU may request information on the association more frequently.

In examples, a base station (e.g., gNB) may have an integrated transceiver (e.g., sub-6 GHz/mmWave) model whereby the base station (e.g., gNB) may be able to use information collected from one band to directly determine how much information the other band collects (e.g., needs to be collected in the other band) and/or whether the other band can be used under one or more (e.g., certain) conditions. In examples, measurements from a first frequency band/range (e.g., sub-6 GHZ) may provide one or more observations to model blockages such that a binary ON-OFF process to account for outages of the second frequency band/range (e.g., mmWave) may be determined. Based on the one or more measurements in the first frequency band/range (e.g., sub-6 GHZ), for example, the base station (e.g., gNB) may determine to (e.g., temporarily) stop using the second frequency band/range (e.g., mmWave) (e.g., until such time as the blockage is gone). In examples, the WTRU may receive one or more indications from the base station (e.g., gNB) to favor the first frequency band/range (e.g., sub-6 GHZ) for a period of time. The WTRU may receive one or more indications from the base station (e.g., gNB) in DCI to favor the first frequency band/range (e.g., sub-6 GHZ) for a period of time.

In addition to beamforming, a first frequency band/range (e.g., sub-6 GHZ) can be used as a fallback (e.g., secondary) data transfer and/or reception mechanism. For example, a first and/or a second frequency band/range (e.g., sub-6 GHz and/or mmWave) may be modeled as individual network nodes with one or more dedicated queues resulting in the optimal transmission policy across the two interfaces being transformed into an optimal scheduling problem across the nodes with the first and/or second frequency bands/ranges. In such a system, for example, determining whether a packet may be added to the queue for the first frequency band/range (e.g., sub-6 GHZ) and/or the queue for the second frequency band/range (e.g., mmWave) may depend on a (pre) configured threshold at the base station (e.g., gNB) such that the scheduler routes the packet and/or traffic to a particular queue if the queue length is smaller than the (pre) configured threshold. Such a dynamic threshold-based scheduling mechanism may be able to effectively capture the dynamics of channels (e.g., mmWave) and/or maximize channel utilization.

In one or more (e.g., any) scenarios involving association between beam resources, the association may be used by the WTRU and/or the base station (e.g., gNB). For example, the association between beam resources may be used by the WTRU and/or the base station to reduce overhead by having to scan a narrower dimension for mmWave sweeping. For example, the association between beam resources may be used by the WTRU and/or the base station as a backup procedure (e.g., solution). The backup procedure (e.g., solution) may include temporary link failure, for example, in higher frequency band/range (e.g., FR2) due to blockage, where the association may be discarded if the WTRU and/or base station (e.g., gNB) determines that the association is inadequate (e.g., not good enough). A base station (e.g., gNB) may determine the association (e.g., and/or AIML model(s) at the base station). A WTRU may determine the association (e.g., and/or AIML model(s) at the WTRU).

A WTRU may be configured with one or more QCL configurations to indicate which set(s) of RSs is/are expected to have similar large scale channel properties. QCL information may include one or more of the following: identity of reference signal resource (e.g., CSI-RS resource ID, SSB index etc.)-additionally and/or alternatively BWP ID, cell ID and/or the like, type of QCL (e.g., Type A, Type B, Type C, Type D etc.)—where one or more (e.g., each) QCL type may refer to one or more large scale channel parameters like Doppler shift and/or spread, average delay, delay spread, Spatial RX parameter, etc.

A WTRU may determine an association between beam resources for hierarchical beam prediction based on a QCL configuration. The QCL configuration may be extended and/or enhanced to indicate either implicitly or explicitly an association for the purpose of prediction between reference signal(s), beam(s), and/or CSI quantities derived thereof.

The QCL configuration may be extended and/or enhanced to indicate to the WTRU, an association between a first set of beam resources to a second set of beam resources. The association may imply that the first set of beam resources may be used to predict applicable beams from the second set of beam resources. For example, the beam resource may include a CSI-RS resource, an SSB resource, and/or an SRS resource and/or identity thereof, TCI state for DL and/or UL, etc. Additionally or alternatively, the beam resource may correspond to one or more time and/or frequency resources. For example, the first set of beam resources may be configured to be in a first frequency band (e.g., FR1) and/or second set of beam resources may be configured to be in a second frequency band (e.g., FR2). In examples described herein, extensions and/or enhancements to QCL framework may include configuring one or more additional information elements, interpreting existing information elements based on preconfigured rules, etc.

In examples, a WTRU may be configured with a QCL configuration that includes a new QCL type. The new QCL type may indicate that the first set of beam resources configured with the new QCL type when associated with a second set of beam resources (e.g., via TCI state configuration) may imply that the first set of beam resources may be used for predicting the second set of beam resources.

In examples, a WTRU may be configured with a QCL configuration that includes a new QCL type. The new QCL type may indicate a specific CSI quantity associated with a first set of beam resources which may be used by the WTRU to predict the applicable second set of beam resources. For example, a first QCL type may indicate PMI from the first set of beam resources to be used for predicting the second set of beam resources. For example, a second QCL type may indicate CQI from the first set of beam resources to be used for predicting the second set of beam resources. A WTRU may be configured with one or more combinations of one or more different CSI quantities and/or one or more different resources from the first set of beam resources that are applicable for the predicting second set of beam resources.

In examples, a WTRU may be configured with a QCL configuration that includes a (e.g., new) QCL type. The new QCL type may indicate that the first set of beam resources configured with the new QCL type when associated with a plurality of the second set of beam resources (e.g., via TCI state configuration) may imply the potential candidates for prediction. For example, the (e.g., new) QCL type configuration may be used by the WTRU to identify valid candidates within a second set of beam resources when applying prediction based on the first set of beam resources. The WTRU may use the (e.g., new) QCL type configuration and/or the associated beam resources to infer the validity of prediction. For example, the WTRU may be preconfigured with an association between a first beam resource (e.g., CSI-RS associated with FR1 band) and plurality of the second set of beam resources (e.g., two or more CSI-RSs associated with FR2 band). The WTRU may be configured to verify the hierarchical beam prediction output from an AIML model using the preconfigured association. For example, for a given input based on the first set of beam resources, if the AIML model outputs a second beam resource which is within the preconfigured second set of beam resources, the WTRU may determine the AIML model output to be a valid candidate. If the AIML model output does not correspond to a beam within the preconfigured second set of beam resources, the WTRU may ignore the predicted output and/or determine that the AIML model output to be incorrect. In examples, if the AIML model prediction is one of the candidates within the second set of beam resources, the WTRU may activate the one or more TCI states associated with the predicted second set of beam resources. If the AIML model prediction does not correspond to a beam within the preconfigured second set of beam resources, for example, the WTRU may transmit a report to the network indicating the discrepancy between the AIML output and the QCL configuration.

What is claimed is:

1.-20. (canceled)

21. A wireless transmit/receive unit (WTRU) comprising:
a processor configured to:
perform one or more channel state information (CSI) measurements on a first set of reference signals (RSs) associated with a first set of transmission configuration indicator (TCI) states;
predict one or more CSI parameters for a second set of TCI states based on the CSI measurements performed on the first set of RSs associated with the first set of TCI states;
receive a first indication to activate or deactivate a first TCI state in the first set of TCI states;
predict to activate or deactivate a second TCI state in the second set of TCI states based on the first indication to activate or deactivate the first TCI state of the first set of TCI states and the predicted one or more CSI parameters for the second set of RSs; and
send a second indication that the second TCI state in the second set of TCI states has been activated or deactivated.

22. The WTRU of claim 21, wherein the one or more CSI parameters for the second set of TCI states is predicted based on a precoding matrix indicator (PMI) determined from the CSI measurements performed on the first set of RSs associated with the first set of TCI states.

23. The WTRU of claim 21, wherein the first set of TCI states is associated with a first frequency range and the second set of TCI states is associated with a second frequency range.

24. The WTRU of claim 21, wherein the processor is further configured to determine a spatial association between the first set of RSs and the second set of RSs, wherein the one or more CSI parameters for the second set of RSs is predicted based on the spatial association.

25. The WTRU of claim 21, wherein the first set of RSs is associated with a first set of beam resources and the second set of RSs is associated with a second set of beam resources.

26. The WTRU of claim 25, wherein the first set of beam resources is in a first frequency range and the second set of beam resources is in a second frequency range.

27. The WTRU of claim 25, wherein the first set of beam resources comprises a larger beamwidth than the second set of beam resources.

28. The WTRU of claim 21, wherein the first indication is received via a medium access control control element (MAC-CE).

29. The WTRU of claim 21, wherein the processor is further configured to determine one or more parameters for the second set of RSs based on one or more artificial intelligence or machine learning models.

30. The WTRU of claim 21, wherein the processor is further configured to receive configuration information associated the first set of RSs and the second set of RSs.

31. A method performed by a wireless transmit/receive unit (WTRU), the method comprising:
performing one or more channel state information (CSI) measurements on a first set of reference signals (RSs) associated with a first set of transmission configuration indicator (TCI) states;
predicting one or more CSI parameters for a second set of TCI states based on the CSI measurements performed on the first set of RSs associated with the first set of TCI states;
receiving a first indication to activate or deactivate a first TCI state in the first set of TCI states;
predicting to activate or deactivate a second TCI state in the second set of TCI states based on the first indication to activate or deactivate the first TCI state of the first set of TCI states and the predicted one or more CSI parameters for the second set of RSs; and
sending a second indication that the second TCI state in the second set of TCI states has been activated or deactivated.

32. The method of claim 31, wherein the one or more CSI parameters for the second set of TCI states is predicted based on a precoding matrix indicator (PMI) determined from the CSI measurements performed on the first set of RSs associated with the first set of TCI states.

33. The method of claim 31, wherein the first set of TCI states is associated with a first frequency range and the second set of TCI states is associated with a second frequency range.

34. The method of claim 31, further comprising determining a spatial association between the first set of RSs and the second set of RSs, wherein the one or more CSI parameters for the second set of RSs is predicted based on the spatial association.

35. The method of claim 31, wherein the first set of RSs is associated with a first set of beam resources and the second set of RSs is associated with a second set of beam resources.

36. The method of claim 35, wherein the first set of beam resources is in a first frequency range and the second set of beam resources is in a second frequency range.

37. The method of claim 35, wherein the first set of beam resources comprises a larger beamwidth than the second set of beam resources.

38. The method of claim 31, wherein the first indication is received via a medium access control control element (MAC-CE).

39. The method of claim 31, further comprising determining one or more parameters for the second set of RSs based on one or more artificial intelligence or machine learning models.

40. The method of claim 31, further comprising receiving configuration information associated the first set of RSs and the second set of RSs.
